(19) United States
(12) Patent Application Publication
(10) Pub. No.: US 2026/0099450 A1
(43) Pub. Date: Apr. 9, 2026

(54) CHAIN-BASED TIME-DIVISION MULTIPLEXING LOGIC CIRCUIT

(71) Applicant: REBELLIONS INC., Seongnam-si (KR)

(72) Inventor: Hyunje JO, Seongnam-si (KR)

(21) Appl. No.: 19/219,896

(22) Filed: May 27, 2025

(30) Foreign Application Priority Data
Oct. 4, 2024 (KR) 10-2024-0135025

(51) Int. Cl. G06F 13/20

(52) U.S. Cl. CPC G06F 13/20; G06F 2213/40

(57) ABSTRACT

A processor includes a parallel-in serial-out (PISO) shift register, a combinational logic circuit, and a serial-in parallel-out (SIPO) shift register. The PISO shift register has a plurality of input ports configured to parallelly receive a plurality of electronic logic signals. The combinational logic circuit has a first input port connected to the output port of the PISO shift register and generates an electronic logic signal to be output to a first output port of the combinational logic circuit based on an electronic logic signal applied to the first input port of the combinational logic circuit. The SIPO shift register has an input port connected to the first output port of the combinational logic circuit. The SIPO shift register is configured to shift stored electronic logic signals with an electronic logic signal applied to the input port of the SIPO shift register and parallelly output stored electronic logic signals.

### CROSS REFERENCE TO RELATED APPLICATION

The present application claims priority to Korean Patent Application No. 10-2024-0135025, filed on Oct. 4, 2024, the entire contents of which are incorporated herein for all purposes by this reference in its entirety.

### TECHNICAL FIELD

The present disclosure relates to a processor including circuitry, and more particularly to, for example, but not limited to a chain-based time-division multiplexing logic circuit.

### BACKGROUND

With the development of Artificial Intelligence (AI) technology, AI services utilizing it are becoming more widespread, and AI hardware for AI services is being researched and developed, and various types of chips are being designed and studied to improve performance.

Meanwhile, in the chip design process where chip design changes are frequently performed, FPGAs (Field Programmable Gate Arrays) are being used because design changes may be repeatedly applied. In particular, FPGAs are being widely used for the purpose of verifying chip designs such as ASICs (Application Specific Integrated Circuits).

However, the internal resource capacity of FPGAs may be limited, and accordingly, if the chip design or logic size is larger than a certain size, it is difficult to implement it in FPGAs.

Accordingly, there is a demand for a method or system that may implement complex chip designs in FPGAs.

The description set forth in the background section should not be assumed to be prior art merely because it is set forth in the background section. The background section may describe aspects or embodiments of the present disclosure.

### SUMMARY

The present disclosure is directed to improvements in a processor including circuitry. In particular, the present disclosure is directed to a chain-based time-division multiplexing logic circuit.

An object of the present disclosure is to provide an FPGA and a data processing method applied with a chain-based time-division multiplexing to solve the above problems.

In order to achieve the object, an integrated circuit according to an embodiment of the present disclosure includes: wherein the logic unit sequentially receives input data, state values, and previous output data of computations from the input wrapper chain, the module state register, and the output chain register, and wherein the logic unit sequentially derives computation values of the computations by performing the computations sequentially.

According to another embodiment of the present disclosure, a data processing method, comprising: sequentially transmitting input data, state values, and previous output data of computations from an input wrapper chain, a module state register, and an output chain register to a logic unit, and sequentially deriving, by the logic unit, computation values of the computations by performing the computations sequentially, wherein the input wrapper chain, the module state register, the output chain register and the logic unit are included in a module, and wherein the input wrapper chain, the module state register and the output chain register are connected to the logic unit.

According to an embodiment of the present disclosure, a circuit may be configured to perform computations repeatedly through one computation core, and the circuit may have an effect of overcoming FPGA capacity limitations and processing speed limitations by saving a resource capacity required for chip design implementation.

According to an embodiment of the present disclosure, by reducing the complexity in configuring a circuit to be repeatedly performed in units of computation cores, the time for implementing the chip design in FPGA may be saved, and an efficiency of verifying the chip design in FPGA may be improved.

According to an embodiment of the present disclosure, additional controls that may incur overhead in the verification process of a chip design implemented in an FPGA may not be required, thereby reducing complexity and increasing efficiency.

### BRIEF DESCRIPTION OF THE DRAWINGS

FIG. 1 is a diagram illustrating an FPGA according to an embodiment of the present disclosure.

FIG. 2 is a diagram for explaining TDM of FPGA in detail.

FIGS. 3A and 3B are diagrams showing an embodiment of an FPGA to which a chain-based time-division multiplexing is applied according to one embodiment of the present disclosure.

FIG. 3C shows operations of circuitry of FIG. 3B according to clock signals and a select signal in accordance with an embodiment.

FIG. 4 is a diagram for explaining in detail an embodiment of an FPGA to which a chain-based time-division multiplexing according to an embodiment of the present disclosure is applied.

FIGS. 5A to 5G are diagrams for explaining in detail an example of data transmission in an FPGA to which a chain-based time-division multiplexing according to an embodiment of the present disclosure is applied.

FIG. 6 is a diagram for explaining in detail an embodiment of a clock of an FPGA to which a chain-based time-division multiplexing according to an embodiment of the present disclosure is applied.

FIG. 7 is a flowchart for explaining in detail a data processing method in an FPGA according to an embodiment of the present disclosure.

### DETAILED DESCRIPTION

Hereinafter, example details for the practice of the present disclosure will be described in detail with reference to the accompanying drawings. However, in the following description, detailed descriptions of well-known functions or configurations will be omitted if it may make the subject matter of the present disclosure rather unclear.

In the accompanying drawings, the same or corresponding components are assigned the same reference numerals. In addition, in the following description of various examples, duplicate descriptions of the same or corresponding components may be omitted. However, even if descriptions of components are omitted, it is not intended that such components are not included in any example.

Advantages and features of the disclosed examples and methods of accomplishing the same will be apparent by referring to examples described below in connection with the accompanying drawings. However, the present disclosure is not limited to the examples disclosed below, and may be implemented in various forms different from each other, and the examples are merely provided to make the present disclosure complete, and to fully disclose the scope of the disclosure to those skilled in the art to which the present disclosure pertains.

The terms used herein will be briefly described prior to describing the disclosed example(s) in detail. The terms used herein have been selected as general terms which are widely used at present in consideration of the functions of the present disclosure, and this may be altered according to the intent of an operator skilled in the art, related practice, or introduction of new technology. In addition, in specific cases, certain terms may be arbitrarily selected by the applicant, and the meaning of the terms will be described in detail in a corresponding description of the example(s). Therefore, the terms used in the present disclosure should be defined based on the meaning of the terms and the overall content of the present disclosure rather than a simple name of each of the terms.

As used herein, the singular forms “a,” “an,” and “the” are intended to include the plural forms as well, unless the context clearly indicates the singular forms. Further, the plural forms are intended to include the singular forms as well, unless the context clearly indicates the plural forms. Further, throughout the description, when a portion is stated as “comprising (including)” a component, it is intended as meaning that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or configured to play one or more processors. Accordingly, as an example, the “module” or “unit” may include components such as software components, object-oriented software components, class components, and task components, and at least one of processes, functions, attributes, procedures, subroutines, program code segments, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units.”

A “module” or “unit” may be implemented as a processor and a memory, or may be implemented as a circuit (circuitry). Terms such as “circuit (circuitry)” may refer to a circuit in hardware, but may also refer to a circuit in software. The “processor” should be interpreted broadly to encompass a general-purpose processor, a Central Processing Unit (CPU), a microprocessor, a Digital Signal Processor (DSP), a controller, a microcontroller, a state machine, and so forth. Under some circumstances, “processor” may refer to an application-specific integrated circuit (ASIC), a programmable logic device (PLD), or a field-programmable gate array (FPGA), and so on. The “processor” may refer to a combination for processing devices, e.g., a combination of a DSP and a microprocessor, a combination of a plurality of microprocessors, a combination of one or more microprocessors in conjunction with a DSP core, or any other combination of such configurations. In addition, the “memory” should be interpreted broadly to encompass any electronic component that is capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or marking data storage, registers, and so on. The memory is said to be in electronic communication with a processor if the processor can read information from and/or write information to the memory. The memory integrated with the processor is in electronic communication with the processor.

In the present disclosure, “each of a plurality of A” may refer to each of all components included in the plurality of A, or may refer to each of some of the components included in a plurality of A.

In addition, terms such as first, second, A, B, (a), (b), etc. used in the following examples are only used to distinguish certain components from other components, and the nature, sequence, order, etc. of the components are not limited by the terms.

In addition, in the following examples, if a certain component is stated as being “connected,” “combined” or “coupled” to another component, it is to be understood that there may be yet another intervening component “connected,” “combined” or “coupled” between the two components, although the two components may also be directly connected or coupled to each other.

In addition, as used in the following examples, “comprise” and/or “comprising” does not foreclose the presence or addition of one or more other elements, steps, operations, and/or devices in addition to the recited elements, steps, operations, or devices.

In addition, in the following examples, “determining whether it is less than” or “if it is less than” are disclosed, but “determining whether it is less than or equal to” or “if it is less than or equal to” may also be applied to the examples.

Before describing various examples of the present disclosure, terms used herein will be explained.

In the present disclosure, a field programmable gate array (FPGA) may mean a type of PLD (Programmable Logic Device) used to design a digital circuit that performs a specific operation through a program. In other words, FPGA may be a programmable hardware chip.

In the present disclosure, FPGA may include a configurable logic block (CLB) and an input output block (IOB), and a configurable connection circuit connecting the two. In addition, the CLB may include at least two kinds of sub-circuits, and the sub-circuits may be a register circuit such as a flip-flop and/or a function generation circuit implemented as a look-up table (LUT). FPGA may include a plurality of LUTs and may be programmed to operate as a desired digital logic circuit.

In addition, in the present disclosure, a “system” or an “FPGA system” may refer to a device including FPGA. In addition, in the present disclosure, an “integrated circuit” may refer to an application specific integrated circuit (ASIC), a programmable logic device (PLD), an FPGA, and the like.

In addition, in the present disclosure, a “module” may refer to a circuit or device including the register circuit such as the flip-flop and/or a function generation circuit implemented with an LUT. In addition, in the present disclosure, “LUT” may mean a combination logic circuit composed of an AND basic element, an OR basic element, and/or a NOT basic element. The module may include at least one LUT.

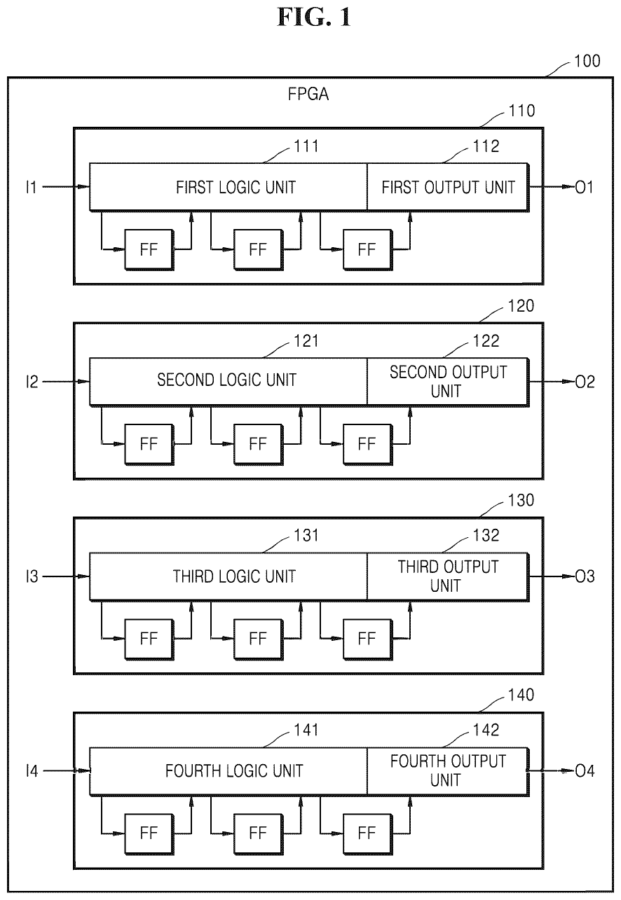

FIG. 1 is a diagram illustrating an FPGA according to an embodiment of the present disclosure. Referring to FIG. 1, the FPGA 100 may include a plurality of modules according to a target chip design for a specific purpose. Each module (1st module, 2nd module, 3rd module, 4th module, etc.) included in the FPGA 100 may be a logic block including a basic processing configuration such as a multiplexer, a register, a flip-flop (FF), and/or a LUT.

For example, referring to FIG. 1, each module may include a logic unit, an output unit, and/or an FF. For example, the logic unit and the output unit may be function generation circuits implemented as LUTs. Also, for example, the FF included in each module may be called a shift FF. For example, a first module 110 may include a first logic unit 111 and a first output unit 112, a second module 120 may include a second logic unit 121 and a second output unit 122, a third module 130 may include a third logic unit 131 and a third output unit 132, and a fourth module 140 may include a fourth logic unit 141 and a fourth output unit 142. Meanwhile, although the figure illustrates the FPGA as including four modules, it is not limited thereto and may be configured to include a different or greater number of modules.

In addition, for example, each module may include at least one FF. Meanwhile, although the figure illustrates that the module includes three FFs, it is not limited thereto and may be configured to include a different or greater number of FFs.

A module may derive an output data by calculating an input data. For example, referring to FIG. 1, a first module 110 may derive an output data O1 by calculating an input data I1, a second module 120 may derive an output data O2 by calculating an input data I2, a third module 130 may derive an output data O3 by calculating an input data I3, and a fourth module 140 may derive an output data O4 by calculating an input data I4.

In addition, for example, the FPGA 100 may include a Vector Unit VU, an Extension Vector Unit (XVU), and/or an Activation Buffer (AB). The FPGA 100 may include a VU, an XVU, and/or an AB based on a chip design.

Meanwhile, FPGA is used instead of ASIC (Application Specific Integrated Circuit) that cannot be modified in the chip design process where chip design changes are frequently performed according to operation test results because FPGA may repeatedly apply design changes.

However, the internal resource capacity of the FPGA may be limited, and accordingly, if the chip design or logic size exceeds a certain size, it may be difficult or impossible to implement it all in the FPGA. To overcome this limitation of the FPGA capacity and implement the chip design in the FPGA, timing division multiplexing (TDM) may be proposed.

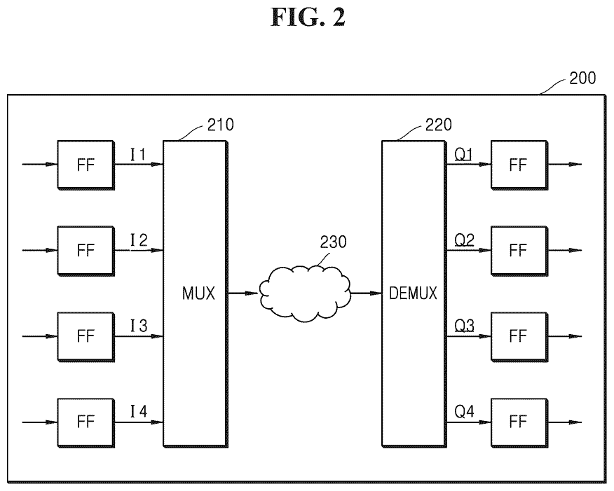

FIG. 2 is a diagram for explaining TDM of FPGA in detail.

Referring to FIG. 2, the FPGA 200 may include a multiplexer 210, a demultiplexer 220, and a LUT 230. The LUT 230 may be an arithmetic circuit that derives output data by calculating input data. For example, according to TDM, the multiplexer may select one of input data and input it to a LUT, and the LUT 230 may process the input data and transmit the output data to the demultiplexer 230. The demultiplexer may transmit the transmitted output data to a flip-flop for the input data. For example, input data I1, I2, I3, and I4 may be selected in order and transmitted to an internal calculator.

Although the resource limitations of the FPGA may be overcome with the TDM, in order to use the same internal calculator (i.e., the LUT 230) multiple times, the internal calculator must alternately calculate the values where necessary, and therefore the TDM may be applied only to a very small portion. Therefore, there may be limitations in the application of the TDM in an ASIC, for example, a Natural Processing Unit (NPU) environment that is repeated in units of large-sized modules. In addition, the TDM may generate overhead and increase complexity in a process of selecting input data from multiple locations and transmitting output data to the corresponding part.

Therefore, a chain-based time-division multiplexing is proposed as a way to overcome the resource limitations of FPGA. For example, according to the chain-based time-division multiplexing, a circuit may be configured to repeatedly perform computations in units of repeated computation modules, and through the circuit, the resource capacity required for computations for chip design implementation may be saved, thereby generating an effect of overcoming the limitations of FPGA capacity restrictions. In addition, additional controls that may generate overhead in a computation process for chip implementation may not be required, and thus complexity may be reduced and efficiency may be increased.

For example, according to the chain-based time-division multiplexing, an FPGA may be configured to sequentially perform computations with a LUT without separate control by configuring the LUT for computations that are commonly included in modules as one and configuring a chain in which input data is sequentially transmitted. The LUT for the computation may also be referred to as a computation core.

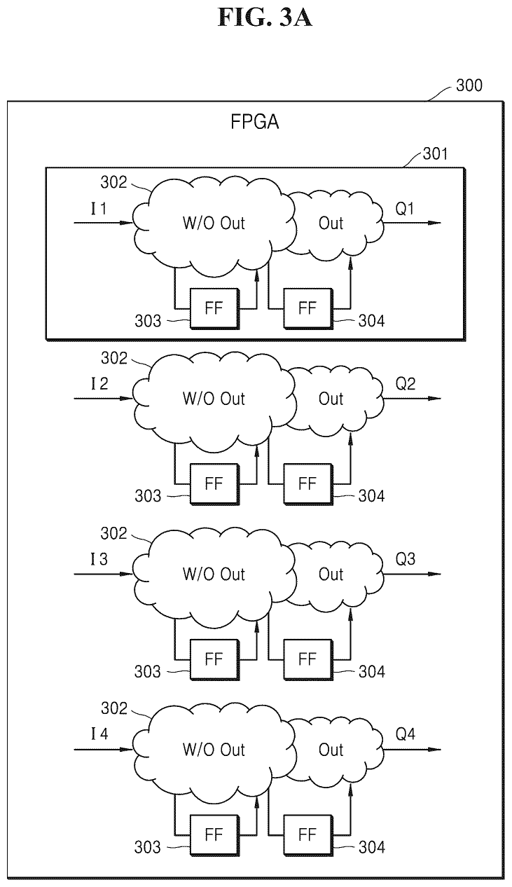

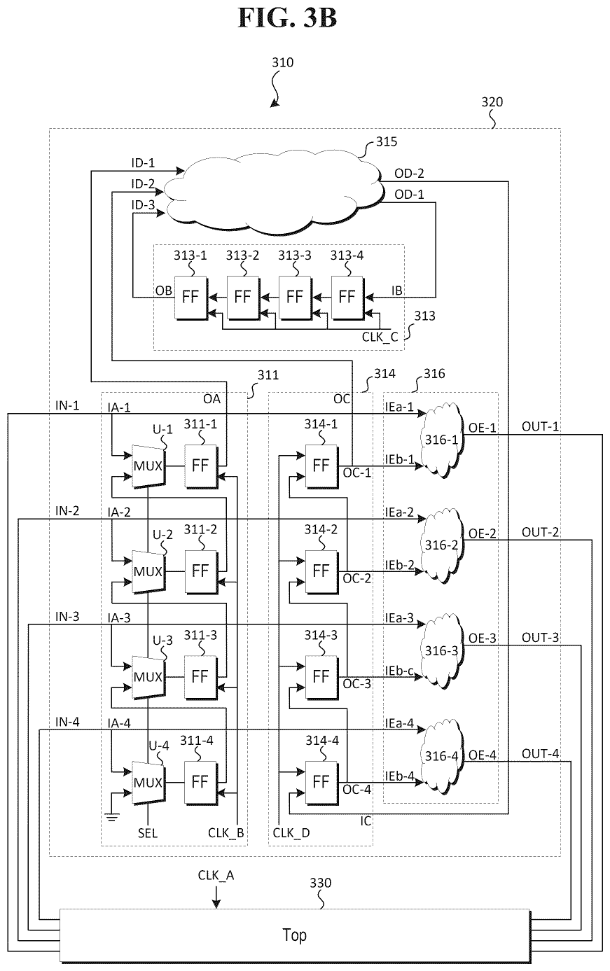

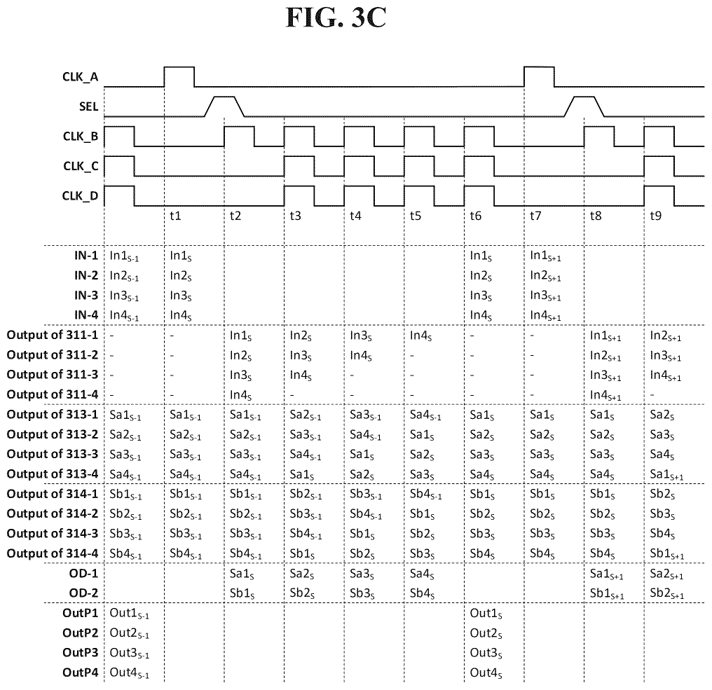

FIGS. 3A and 3B are diagrams showing an embodiment of an FPGA to which a chain-based time-division multiplexing is applied according to one embodiment of the present disclosure. The FPGA 310) of FIG. 3B may be a structure that briefly illustrates an FPGA to which the chain-based time-division multiplexing is applied.

Referring to FIG. 3A, the FPGA may include a plurality of identical modules 301. That is, as illustrated in FIG. 3A, a plurality of modules including the same LUT may be used, and an FPGA that applies a chain-based time-division multiplexing that configures repeatedly used LUTs into one may be proposed. FIG. 3B may represent an embodiment of a FPGA to which the chain-based time-division multiplexing is applied.

Referring to FIG. 3B, the FPGA 310 may include a chain-based TDM logic circuitry module 320 and a top logic circuitry module 330. The chain-based TDM logic circuitry module 320 may include an input wrapper chain 311, a module state register 313, an output chain register 314, a logic unit 315, and an output unit 316.

The chain-based TDM logic circuitry module 320 may have N input ports IN-k and N output ports OUT-k (k=1 . . . N). The positive number N may represent the total number of computations and may be greater than 1. During a current stage of a plurality of stages, the chain-based TDM logic circuitry module 320 may receive N electronic logic signals in parallel through the N input ports, respectively. During the current stage, the chain-based TDM logic circuitry module 320 may output N electronic logic signals in parallel through the N output ports, respectively. A logic signal applied to the k-th input port IN-k for the current stage may be used for generating a logic signal to be output through the k-th output port OUT-k for the k-th computation of the current stage.

For example, as shown in FIG. 3B, when N is equal to 4, the chain-based TDM logic circuitry module 320 may have four input ports IN-1, IN-2, IN-3, IN-4 for receiving 4 electronic logic input signals and four output ports OUT-1, OUT-2, OUT-3, OUT-4 for outputting 4 electronic logic output signals.

During the current stage, the top logic circuitry module 330 may apply a plurality of electronic logic input signals in parallel to the chain-based TDM logic circuitry module 320 and receives a plurality of electronic logic output signals in parallel from the chain-based TDM logic circuitry module 320. In some embodiments, a clock signal CLK_A may be applied to the top logic circuitry module 330. For example, at each rising edge of the clock signal CLK_A, the top logic circuitry module 330 may apply a plurality of electronic logic input signals in parallel to the chain-based TDM logic circuitry module 320 and receives a plurality of electronic logic output signals in parallel from the chain-based TDM logic circuitry module 320.

The input wrapper chain 311 may have N input ports IA-k (k=1 . . . N) and an output port OA. In some embodiments, the k-th input port IA-k may be connected to the k-th input port IN-k of the chain-based TDM logic circuitry module 320.

In some embodiments, the input wrapper chain 311 may include or correspond to a parallel-in serial-out (PISO) shift register, where n is a positive integer equal to or greater than 1. In some embodiments, the PISO shift register may parallelly receive a plurality of electronic logic signals through a plurality of input ports of the PISO shift register, store the received electronic logic signals, and serially output the stored electronic logic signals through an output port of the PISO shift register.

In some embodiments, during the current stage, the input wrapper chain 311 may receive N electronic logic signals in parallel through the N input ports IA-k (k=1 . . . N) and sequentially output the N electronic logic signals in serial through the output port OA.

The logic unit 315 may be a combinational logic circuit or a LUT. The logic unit 315 have input ports ID-1, ID-2, ID-3 and output ports OD-1, OD-2. The input port ID-1 of the logic unit 315 may be connected to the output port OA of the input wrapper chain 311. In some embodiments, the combinational logic circuit may not store any state and may not operate according to a clock signal.

The input port ID-1 of the logic unit 315 may receive electronic logic signals in serial.

The input port ID-2 of the logic unit 315 may receive a first set of electronic logic input signals in serial.

The input port ID-3 of the logic unit 315 may receive a second set of electronic logic input signals in serial.

In some embodiments, the logic unit 315 may generate a first set of electronic logic output signals and a second set of electronic logic output signals based on the electronic logic signals of the input port ID-1, the first set of electronic logic input signals of the input port ID-2, and the second set of electronic logic input signals in serial of the input port ID-3. In some embodiments, electronic logic output signals which do not affect output signals of the chain-based TDM logic circuitry module 320 for the current stage may be referred to as the first set of electronic logic output signals of the logic unit 315. In some embodiments, electronic logic output signals which affect output signals of the chain-based TDM logic circuitry module 320 for the current stage may be referred to as the second set of electronic logic output signals of the logic unit 315. The logic unit 315 may output the first set of electronic logic output signals and the second set of electronic logic output signals through the output ports OD-1, OD-2, respectively.

The module state register 313 may have an input port IB and an output port OB. In some embodiments, the input port IB of the module state register 313 may be connected to the output port OD-1 of the logic unit 315. In some embodiments, the output port OB of the module state register 313 may be connected to the input port ID-3 of the logic unit 315.

In some embodiments, the module state register 313 may include or correspond to a serial-in serial-out (SISO) shift register, where n is a positive integer equal to or greater than 1. In some embodiments, the SISO shift register may shift stored electronic logic signals with an electronic logic signal applied to an input port of the SISO shift register and serially output stored electronic logic signals through an output port of the SISO shift register.

In some embodiments, at the beginning of the current stage, the module state register 313 may store N electronic logic signals which have been received during the previous stage. In some embodiments, during the current stage, the module state register 313 may sequentially receive N electronic logic signals in serial through the input ports IB and sequentially output N electronic logic signals of the previous stage in serial through the output port OB.

The output chain register 314 may have an input port IC, an output port OC, and N output ports OC-k (k=1 . . . N). In some embodiments, the input port IC of the output chain register 314 may be connected to the output port OD-2 of the logic unit 315. In some embodiments, the output port OC of the output chain register 314 may be connected to the input port ID-2 of the logic unit 315. In some embodiments, the output port OC of the output chain register 314 may be connected to the 1st output port OC-1 of the output chain register 314.

In some embodiments, the output chain register 314 may include or correspond to a serial-in parallel-out (SIPO) shift register, where n is a positive integer equal to or greater than 1. In some embodiments, the SIPO shift register may shift stored electronic logic signals with an electronic logic signal applied to an input port of the SIPO shift register and parallelly output stored electronic logic signals through a plurality of output ports of the SIPO shift register.

In some embodiments, at the beginning of the current stage, the output chain register 314 may store N electronic logic signals which have been received during the previous stage. In some embodiments, during the current stage, the output chain register 314 may sequentially receive N electronic logic signals in serial through the input ports IC and sequentially output N electronic logic signals of the previous stage in serial through the output port OC. During the current stage, the output chain register 314 may output N electronic logic signals in parallel through the N output ports OC-k (k=1 . . . N).

The output unit 316 may have a first set of input ports IEa-k, a second set of input ports IEb-k, and output ports OE-k (k=1 . . . N). In some embodiments, the k-th input port IEa-k of the first set is connected to the k-th input port IN-k of the chain-based TDM logic circuitry module 320. In some embodiments, the k-th input port IEb-k of the second set is connected to k-th output port OC-k of the output chain register 314. In some embodiments, the k-th output port OE-k may be connected to the k-th output port OUT-k of the chain-based TDM logic circuitry module 320.

In some embodiments, the output unit 316 may generate N electronic logic output signals based on a first set of electronic logic input signals received through the first set of input port IEa-k and a second set of electronic logic input signals received through the second set of input port IDb-k. The output unit 316 may output the N electronic logic output signals through the output ports OE-k (k=1 . . . N), respectively.

The input wrapper chain 311 may include at least one flip-flop 311-k (k=1 . . . N) and/or at least one multiplexer U-k, where k=1 . . . N.

In some embodiments, a first input port of the k-th multiplexer U-k may be connected to the k-th input port IA-k of the input wrapper chain 311. In some embodiments, a second input port of the k-th multiplexer U-k may be connected to an output port of the (k+1)-th flip-flop 311-(k+1), where k=1 . . . (N−1). In some embodiments, an output port of the 1st flip-flop 311-1 may be connected to the output port OA of the input wrapper chain 311. In some embodiments, a second input port of the N-th multiplexer U-N may be connected to a ground. In some embodiments, a input port of the k-th flip-flop 311-k may be connected to an output port of the k-th multiplexer U-k.

In some embodiments, a select signal SEL may be applied to the k-th multiplexer U-k. For example, if the select signal SEL is low, the k-th multiplexer U-k may the output electronic logic signal of the first input port of the k-th multiplexer U-k. If the select signal SEL is high, the k-th multiplexer U-k may the output electronic logic signal of the second input port of the k-th multiplexer U-k.

In some embodiments, a clock signal CLK-B may be applied the k-th flip-flop 311-k (k=1 . . . N). For example, the k-th flip-flop 311-k (k=1 . . . N) may output the electronic logic signal of the input port of the k-th flip-flop 311-k (k=1 . . . N) at the rising edge (or the falling edge) of the clock signal CLK-B. The k-th flip-flop 311-k (k=1 . . . N) may not change the output of the k-th flip-flop 311-k (k=1 . . . N) when the clock signal CLK-B does not make the rising edge (or the falling edge).

The module state register 313 may include at least one flip-flop 313-k (k=1 . . . N). In some embodiments, an output port of k-th flip-flop 313-k may be connected to an input port of (k−1)-th flip-flop 313-(k−1), where i=2 . . . N. In some embodiments, the input port of the N-th flip-flop 313-N may be connected to the input port IB of the module state register 313. In some embodiments, an output port of the 1st flip-flop 313-1 may be connected to the output port OB of the module state register 313.

In some embodiments, a clock signal CLK-C may be applied the k-th flip-flop 313-k (k=1 . . . N). For example, the k-th flip-flop 313-k (k=1 . . . N) may output the electronic logic signal of the input port of the k-th flip-flop 313-k (k=1 . . . N) at the rising edge (or the falling edge) of the clock signal CLK-C. The k-th flip-flop 313-k (k=1 . . . N) may not change the output of the k-th flip-flop 313-k (k=1 . . . N) when the clock signal CLK-C does not make the rising edge (or the falling edge).

The output chain register 314 may include at least one flip-flop 314-k (k=1 . . . N). In some embodiments, an output port of k-th flip-flop 314-k may be connected to an input port of (k−1)-th flip-flop 314-(k−1), where i=2 . . . N. In some embodiments, the input port of the N-th flip-flop 314-N may be connected to the input port IC of the output chain register 314. In some embodiments, an output port of the 1st flip-flop 314-1 may be connected to the output port OC of the output chain register 314. In some embodiments, an output port of the k-th flip-flop 314-k may be connected to the output port OC-k of the output chain register 314.

In some embodiments, a clock signal CLK-D may be applied the k-th flip-flop 314-k (k=1 . . . N). For example, the k-th flip-flop 314-k (k=1 . . . N) may output the electronic logic signal of the input port of the k-th flip-flop 314-k (k=1 . . . N) at the rising edge (or the falling edge) of the clock signal CLK-C. The k-th flip-flop 314-k (k=1 . . . N) may not change the output of the k-th flip-flop 314-k (k=1 . . . N) when the clock signal CLK-C does not make the rising edge (or the falling edge).

The output unit 316 may include at least one output combinational logic circuit 316-k (k=1 . . . N). The first input port of the k-th output combinational logic circuit 316-k may be connected to the k-th input port IEa-k of the first set of the output unit 316. The second input port of the k-th output combinational logic circuit 316-k may be connected to the k-th input port IEb-k of the second set of the output unit 316. The output port of the k-th output combinational logic circuit 316-k may be connected to the k-th output port OE-k of the output unit 316. In some embodiments, all of the output combinational logic circuits 316-k (k=1 . . . N) may be the same. In some embodiments, one of the output combinational logic circuits 316-k (k=1 . . . N) may be different from another of the output combinational logic circuits 316-k (k=1 . . . N).

In some embodiments, the k-th output combinational logic circuit 316-k may generate an electronic logic output signal based on an electronic logic signal applied to the first input port of the k-th output combinational logic circuit 316-k and an electronic logic signal applied to the second input port of the k-th output combinational logic circuit 316-k. The k-th output combinational logic circuit 316-k may output the generated electronic logic output signal to the output port of k-th output combinational logic circuit 316-k.

In some embodiments, the various ports described with reference to FIG. 3B may be multi-bit port. In some embodiments, some or all of the ports may have the same number of bits.

In some embodiments, the flip-flops, the multiplexers, and the shift registers described with reference to FIG. 3B may be multi-bit flip-flops, multi-bit multiplexers, and multi-bit shift registers. The multi-bit flip-flop, the multi-bit multiplexer, and the multi-bit shift register may be referred to as an n-bit flip-flop, an n-bit multiplexer, and an n-bit shift register, respectively. For example, n-bit flip-flop may be implemented by arranging n flip-flops in parallel, where n is a positive integer greater than 1.

The input wrapper chain 311 may be a circuit that transmits input data to the logic unit 315. For example, the input wrapper chain 311 may sequentially transmit the input data to the logic unit 315. First, for example, a MUX of the input wrapper chain 311 may select and transmit one of an input data and a previous input data. That is, the MUX of the input wrapper chain 311 may select one of an input data and a previous input data and transmit it to a flip-flop in the input wrapper chain 311. Through this, a value of the input wrapper chain 311 may be changed into the input data. Thereafter, for example, the input wrapper chain 311 may sequentially transmit input data to the logic unit 315. For example, the input wrapper chain 311 may sequentially transmit input data to the logic unit 315 in the order of input data I1 of a first computation, input data I2 of a second computation, input data I3 of a third computation, and input data I4 of a fourth computation.

In addition, the module state register 313 may be implemented by connecting a shift register or a flip-flop. That is, the module state register 313 may be a register configured by connecting a shift register or a flip-flop.

For example, the module state register 313 may store a state of the logic unit 315. For example, the state of the logic unit 315 may represent a computation value derived from the logic unit 315, and the module state register 313 may store a computation value derived from the logic unit 315. The module state register 313 may sequentially transmit stored state values to the logic unit 315. For example, the module state register 313 may transmit state values to the logic unit 315 in the order of state value of the first computation, state value of the second computation, state value of the third computation, and state value of the fourth computation.

In addition, the output chain register 314 may be configured to be connected to a flip-flop and/or an output unit. The flip-flop of the output chain register 314 may be called an output related flip-flop. The output chain register 314 may sequentially transmit output data (i.e., previous output data) for previous input data for deriving output data to the logic unit 315. For example, the output chain register 314 may transmit previous output data to the logic unit 315 in the order of previous output data of the first computation, previous output data of the second computation, previous output data of the third computation, and previous output data of the fourth computation.

For example, the logic unit 315 may receive input data, a state value, and previous output data of a current computation from the input wrapper chain 311, the module state register 313, and the output chain register 314, and may derive a computation value of the current computation based on the input data, the state value, and the previous output data. That is, for example, the logic unit 315 may sequentially receive input data, a state value, and previous output data of each of the computations, and may sequentially derive computation values of the computations. The derived computation values of the computations may be transmitted to the module state register 313 and the output chain register 314. That is, for example, the derived computation values of the computations may be sequentially transmitted to the module state register 313, and the derived computation values of the computations may be sequentially transmitted to the output chain register 314.

Thereafter, for example, the output unit 316 may calculate output data of the current computation based on the input data of the current computation transmitted from the input wrapper chain 311 and the computation value of the current computation transmitted from the logic unit 315.

Therefore, according to the FPGA of FIG. 3B, values of the computations from the input wrapper chain 311, the module state register 313, and the output chain register 314 may be sequentially transmitted to the logic unit 315 in the order of the computations while the logic unit 315 performs the computations. Here, a value of a computation may include input data, a state value, and previous output data for the computation. During this process, input data in the input wrapper chain 311, state values in the module state register 313, and output data in the output chain register 314 may be moved to exist in their original locations.

Specifically, according to the FPGA illustrated in FIG. 3B to which the chain-based time-division multiplexing is applied, for example, output data may be computed as follows. Input data computed in a unit other than a module in the FPGA may be transmitted to the module. The input data may include input data I1 for a first computation, input data I2 for a second computation, input data I3 for a third computation, and input data I4 for a fourth computation. A MUX of the input wrapper chain 311 may change previous input data stored in a flip-flop in the input wrapper chain 311 into the input data transmitted from the external unit. Thereafter, the input wrapper chain 311 may sequentially transmit input data to the logic unit 315 according to an order of the computations, the module state register 313 may sequentially transmit state values to the logic unit 315 according to the order, and the output chain register 314 may sequentially transmit previous output data to the logic unit 315 according to the order. Thereafter, the logic unit 315 may sequentially derive a computation value of a corresponding computation based on input data, a state value, and previous output data of the corresponding computation that are sequentially transmitted according to the order. For example, the logic unit 315 may derive a computation value of the first computation based on input data, a state value, and previous output data of the first computation that has been transmitted, may derive a computation value of the second computation based on input data, a state value, and previous output data of the second computation that has been transmitted in the next order, may derive a computation value of the third computation based on input data, a state value, and previous output data of the third computation that has been transmitted in the next order, and may derive a computation value of the fourth computation based on input data, a state value, and previous output data of the fourth computation that has been transmitted in the next order. That is, for example, the logic unit 315 may derive a computation value of a nth computation based on input data, a state value, and previous output data of the transmitted nth computation, and may derive a computation value of a n+1th computation based on input data, a state value, and previous output data of the n+1th computation transmitted in the next order. The logic unit 315 may sequentially transmit the computation values of the computations to the module state register 313 and the output chain register 314. Through this, the module state register 313 and the output chain register 314 may store the computation values of the computations. In addition, the output unit 316 may receive input data and the computation values of the computations, and may derive output data of the computations based on the input data and the computation values.

The FPGA according to the embodiment may be configured with a module that allows the entire computation to be repeatedly performed through one calculator (i.e., the logic unit) instead of including a plurality of modules for a plurality of computations, and may generate an effect of overcoming the limitation of FPGA capacity restrictions by saving the resource capacity required for computation for implementing chip design through the circuit.

Meanwhile, a specific example of a FPGA to which the chain-based time-division multiplexing is applied may be as described below. Embodiments described below are examples of a FPGA to which the chain-based time-division multiplexing is applied, and an implementation method of a FPGA to which the chain-based time-division multiplexing is applied is not limited thereto. For example, in the embodiments described below, the logic unit 315 and the output unit 316 of a module in the FPGA may be implemented as a computation core, and the input wrapper chain 311, the module state register 313 and/or the output chain register 314 may be implemented as a wrapper core.

FIG. 3C shows operations of circuitry of FIG. 3B according to clock signals and a select signal in accordance with an embodiment.

In particular, FIG. 3C shows values of ports of circuitry of FIG. 3B, when N is 4.

As shown in FIG. 3C, immediately before time t1, the module 330 applies input signals In1_{S-1}, In2_{S-1}, In3_{S-1}, In4_{S-1} for the (S−1)-th stage to the module 320 and the module 320 provides output signals Out1_{S-1}, Out2_{S-1}, Out3_{S-1}, Out4_{S-1} for the (S−1)-th stage to the module 330. The flip-flops 313-1, 313-2, 313-3, 313-4 output the logic signals Sa1_{S-1}, Sa2_{S-1}, Sa3_{S-1}, Sa4_{S-1} which have been generated by the logic unit 315 during the (S−1)-th stage. The flip-flops 314-1, 314-2, 314-3, 314-4 output the logic signals Sb1_{S-1}, Sb2_{S-1}, Sb3_{S-1}, Sb4_{S-1} which have been generated by the output unit 316 during the (S−1)-th stage. In some embodiments, the logic signal SaX_{S-1} may represent a state which does not affect an output of the module 320 for the X-th computation of the (S−1)-th stage and which is used for the X-th computation of the S-th stage, where X=1 . . . N. In some embodiments, the logic signal SbX_{S-1} may represent a state which affects an output of the module 320 for the X-th computation of the (S−1)-th stage and which is used for the X-th computation of the S-th stage, where X=1 . . . N.

At time t1, since the clock signal CLK-A makes a rising edge, the module 330 applies input signals In1_{S}, In2_{S}, In3_{S}, In4_{S} for the S-th stage to the module 320.

At time t2, since the clock signal CLK-B makes a rising edge and the select signal SEL is high, the flip-flops 311-1, 311-2, 311-3, 311-4 output the logic signals In1_{S}, In2_{S}, In3_{S}, In4_{S}, respectively. The logic unit 315 generates a logic signal Sa1_{S} for the output port OD-1 and a logic signal Sb1_{S} for the output port OD-2 based on an output logic signal In1_{S} of the flip-flop 311-1, an output logic signal Sa1_{S-1} of the flip-flop 313-1, and an output logic signal Sb1_{S-1} of the flip-flop 314-1.

At time t3, since the clock signal CLK-B makes a rising edge and the select signal SEL is low, the flip-flops 311-1, 311-2, 311-3 output the logic signals In2_{S}, In3_{S}, In4_{S}, respectively and the flip-flop 311-4 outputs an invalid logic signal. Since the clock signal CLK-C makes a rising edge, the flip-flops 313-1, 313-2, 313-3, 313-4 output the logic signals Sa2_{S-1}, Sa3_{S-1}, Sa4_{S-1}, Sa1_{S}, respectively. Since the clock signal CLK-D makes a rising edge, the flip-flops 314-1, 314-2, 314-3, 314-4 output the logic signals Sb2_{S-1}, Sb3_{S-1}, Sb4_{S-1}, Sb1_{S}, respectively. The logic unit 315 generates a logic signal Sa2_{S} for the output port OD-1 and a logic signal Sb2_{S} for the output port OD-2 based on an output logic signal In2_{S} of the flip-flop 311-1, an output logic signal Sa2_{S-1} of the flip-flop 313-1, and an output logic signal Sb2_{S-1} of the flip-flop 314-1.

At time t4, since the clock signal CLK-B makes a rising edge and the select signal SEL is low, the flip-flops 311-1, 311-2 output the logic signals In3_{S}, In4_{S}, respectively and the flip-flops 311-3, 311-4 output invalid logic signals. Since the clock signal CLK-C makes a rising edge, the flip-flops 313-1, 313-2, 313-3, 313-4 output the logic signals Sa3_{S-1}, Sa4_{S-1}, Sa1_{S}, Sa2_{S}, respectively. Since the clock signal CLK-D makes a rising edge, the flip-flops 314-1, 314-2, 314-3, 314-4 output the logic signals Sb3_{S-1}, Sb4_{S-1}, Sb1_{S}, Sb2_{S}, respectively. The logic unit 315 generates a logic signal Sa3_{S} for the output port OD-1 and a logic signal Sb3_{S} for the output port OD-2 based on an output logic signal In3_{S} of the flip-flop 311-1, an output logic signal Sa3_{S-1} of the flip-flop 313-1, and an output logic signal Sb3_{S-1} of the flip-flop 314-1.

At time t5, since the clock signal CLK-B makes a rising edge and the select signal SEL is low, the flip-flop 311-1 outputs the logic signals In4_{S} and the flip-flops 311-2, 311-3, 311-4 output invalid logic signals. Since the clock signal CLK-C makes a rising edge, the flip-flops 313-1, 313-2, 313-3, 313-4 output the logic signals Sa4_{S-1}, Sa1_{S}, Sa2_{S}, Sa3_{S}, respectively. Since the clock signal CLK-D makes a rising edge, the flip-flops 314-1, 314-2, 314-3, 314-4 output the logic signals Sb4_{S-1}, Sb1_{S}, Sb2_{S}, Sb3_{S}, respectively. The logic unit 315 generates a logic signal Sa4_{S} for the output port OD-1 and a logic signal Sb4_{S} for the output port OD-2 based on an output logic signal In4_{S} of the flip-flop 311-1, an output logic signal Sa4_{S-1} of the flip-flop 313-1, and an output logic signal Sb4_{S-1} of the flip-flop 314-1.

At time t6, since the clock signal CLK-B makes a rising edge and the select signal SEL is low, the flip-flops 311-1, 311-2, 311-3, 311-4 output invalid logic signals. Since the clock signal CLK-C makes a rising edge, the flip-flops 313-1, 313-2, 313-3, 313-4 output the logic signals Sa1_{S}, Sa2_{S}, Sa3_{S}, Sa4_{S}, respectively. Since the clock signal CLK-D makes a rising edge, the flip-flops 314-1, 314-2, 314-3, 314-4 output the logic signals Sb1_{S}, Sb2_{S}, Sb3_{S}, Sb4_{S}, respectively.

The output combinational logic circuit 316-1 generates an electronic logic signal Out1_{S} based on the logic signals In1_{S} and Sb1_{S}. The output combinational logic circuit 316-2 generates an electronic logic signal Out2_{S} based on the logic signals In2_{S} and Sb2_{S}. The output combinational logic circuit 316-3 generates an electronic logic signal Out3_{S} based on the logic signals In3_{S} and Sb3_{S.} The output combinational logic circuit 316-4 generates an electronic logic signal Out4_{S} based on the logic signals In4_{S} and Sb4_{S}.

In some embodiments, for any port where a signal is omitted in FIG. 3C, the same signal previously applied to the port may still be applied. In some embodiments, for any port where a signal is omitted in FIG. 3C, a floating signal may be applied to the port.

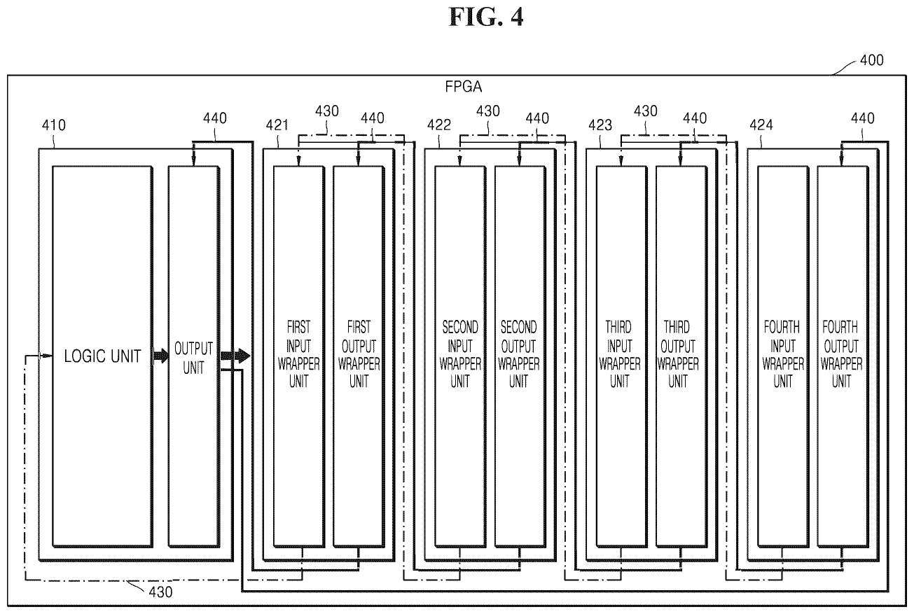

FIG. 4 is a diagram for explaining in detail an embodiment of a FPGA to which a chain-based time-division multiplexing according to an embodiment of the present disclosure is applied.

Referring to FIG. 4, a module of a FPGA 400 may include a computation core 410 and/or a first wrapper core 421 to a fourth wrapper core 424. For example, each wrapper core may include an input wrapper unit and an output wrapper unit. The input wrapper unit and/or the output wrapper unit may be a register. For example, the input wrapper unit and/or the output wrapper unit may store data input at a pulse of a clock and transmit the stored data. Specifically, for example, the input wrapper unit and/or the output wrapper unit may store input data and transmit stored data at a rising edge of a pulse of a clock. The input wrapper unit and/or the output wrapper unit may include a flip-flop. Meanwhile, in the present disclosure, a description that an operation is performed at a pulse of a clock may have same meaning as a description that an operation is performed at a rising edge of a pulse of a clock.

For example, when first data is stored in an input wrapper unit and second data is input at a pulse of a clock, the input wrapper unit may store the second data and output the first data. In addition, for example, when first data is stored in an output wrapper unit and second data is input at a pulse of a clock, the output wrapper unit may store the second data and output the first data.

For example, a first wrapper core 421 may include a first input wrapper unit and a first output wrapper unit, a second wrapper core 422 may include a second input wrapper unit and a second output wrapper unit, a third wrapper core 423 may include a third input wrapper unit and a third output wrapper unit, and a fourth wrapper core 424 may include a fourth input wrapper unit and a fourth output wrapper unit. That is, an nth wrapper core may include an nth input wrapper unit and an nth output wrapper unit.

Meanwhile, although the figure illustrates that the module of the FPGA includes four wrapper cores, it is not limited thereto and may be configured to include a different or greater number of wrapper cores. For example, the module of the FPGA may include N wrapper cores. That is, for example, the module of the FPGA may include a first wrapper core to an Nth wrapper core.

In addition, referring to FIG. 4, a module of the FPGA 400 to which a chain-based time-division multiplexing according to an embodiment of the present disclosure is applied may include an input wrapper chain 430 and/or an output wrapper chain 440.

For example, the input wrapper chain 430 may be a circuit in which input wrapper units of the wrapper cores and a logic unit of the computation core are connected. For example, the input wrapper chain 430 may be a circuit in which input wrapper units of the wrapper cores and a logic unit of the computation core are connected in series.

Referring to FIG. 4, an input wrapper chain 430 may be configured that is sequentially connected from the fourth input wrapper unit of the fourth wrapper core to the first input wrapper unit of the first wrapper core 421, and from the first input wrapper unit to an input of the computation core 410 (i.e., to the logic unit). That is, the input wrapper chain 430 is a circuit in which input wrapper units of wrapper cores and the logic unit of the computation core are sequentially connected, and a nth input wrapper unit and a (n−1)-th input wrapper unit may be connected, and the first input wrapper unit may be connected to the logic unit. Here, n may be greater than 1.

In addition, for example, the output wrapper chain 440 may be a circuit in which an output unit of the computation core and output wrapper units of the wrapper cores are connected. For example, the output wrapper chain 440 may be a circuit in which the output unit of the computation core and the output wrapper units of the wrapper cores are connected in a loop.

Referring to FIG. 4, an output wrapper chain 440 may be configured that is connected from the output unit of the computation core 410 to the fourth output wrapper unit of the fourth sub-core, sequentially connected from the fourth output wrapper unit of the fourth wrapper core to the first output wrapper unit of the first wrapper core 421, and connected from the first input wrapper unit to the output unit of the computation core 410. That is, the output wrapper chain 430 is a circuit in which output wrapper units of wrapper cores and the output unit of the computation core are connected in a loop structure, and the output unit and a last output wrapper unit (i.e., a Nth output wrapper unit of a Nth wrapper core) may be connected, a nth output wrapper unit and a (n−1)-th output wrapper unit may be connected, and a first output wrapper unit may be connected to the output unit. Here, n may be greater than 1.

In the module of the FPGA illustrated in FIG. 4 to which the chain-based time-division multiplexing is applied, input data may be sequentially transmitted to the computation core 410 through the input wrapper chain 430, and output data may be sequentially transmitted to the computation core 410 through the output wrapper chain 440. Specifically, input data of a current period may be sequentially transmitted to the logic unit of the computation core through the input wrapper chain 430 according to a clock, and output data of a previous period may be sequentially transmitted to the output unit of the computation core through the output wrapper chain 440 according to the clock. Here, the current period and the previous period may mean a period of the clock.

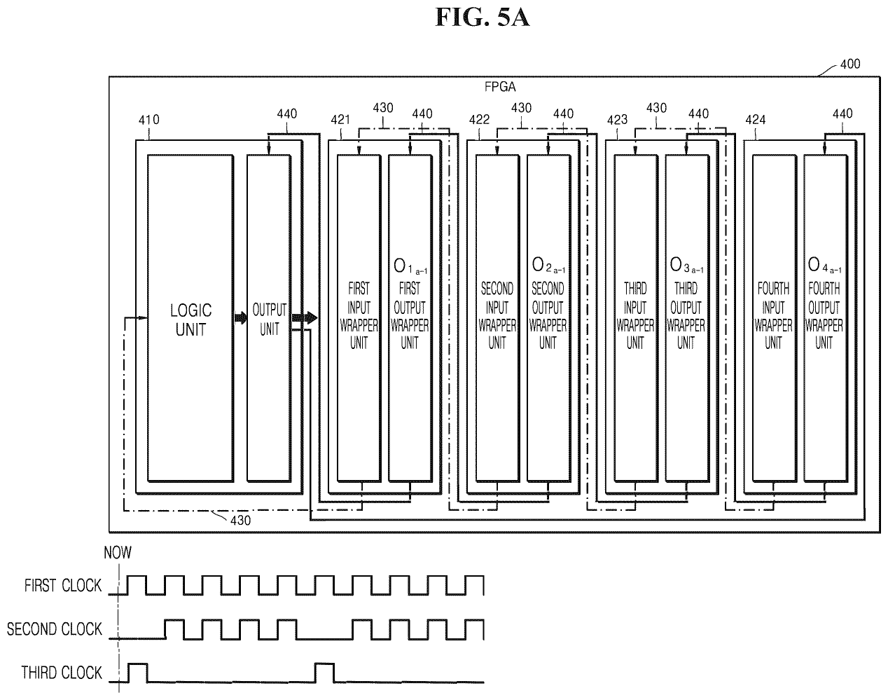

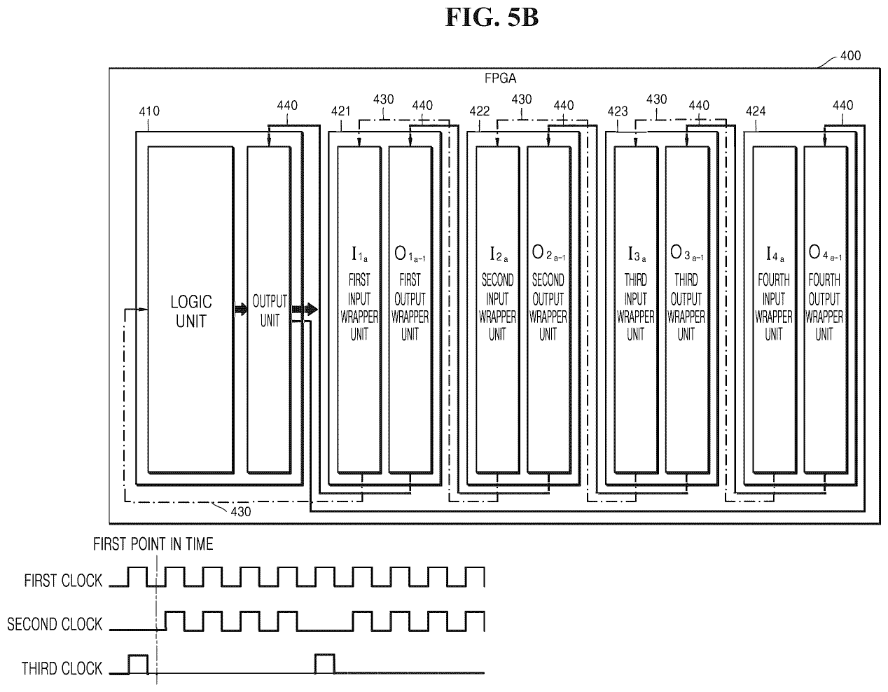

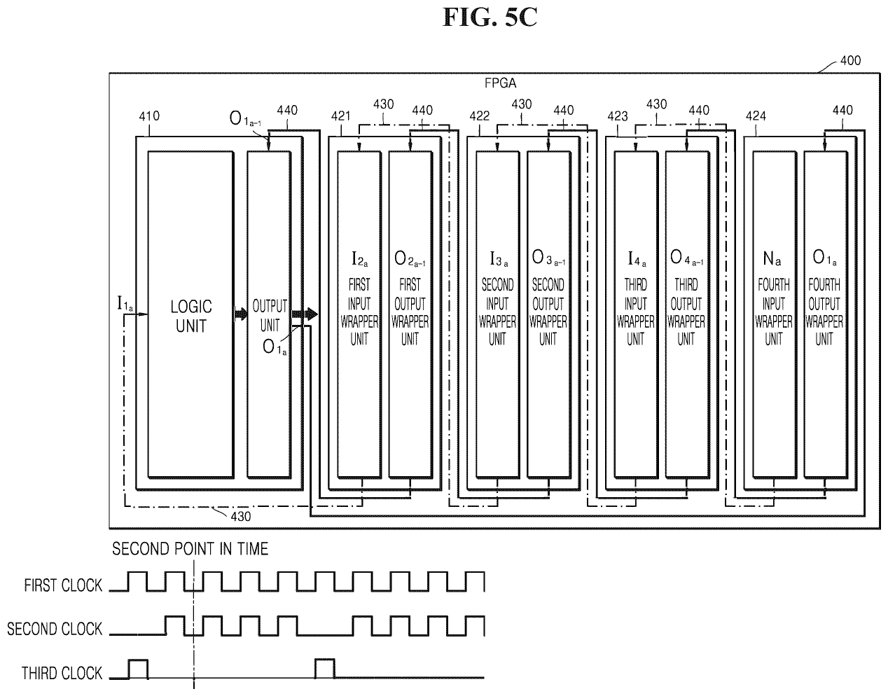

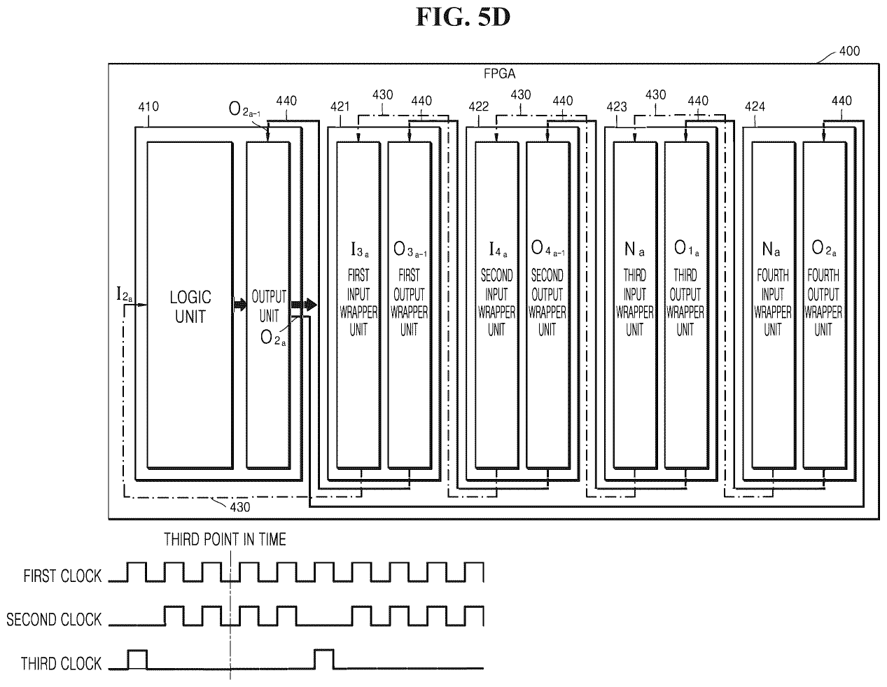

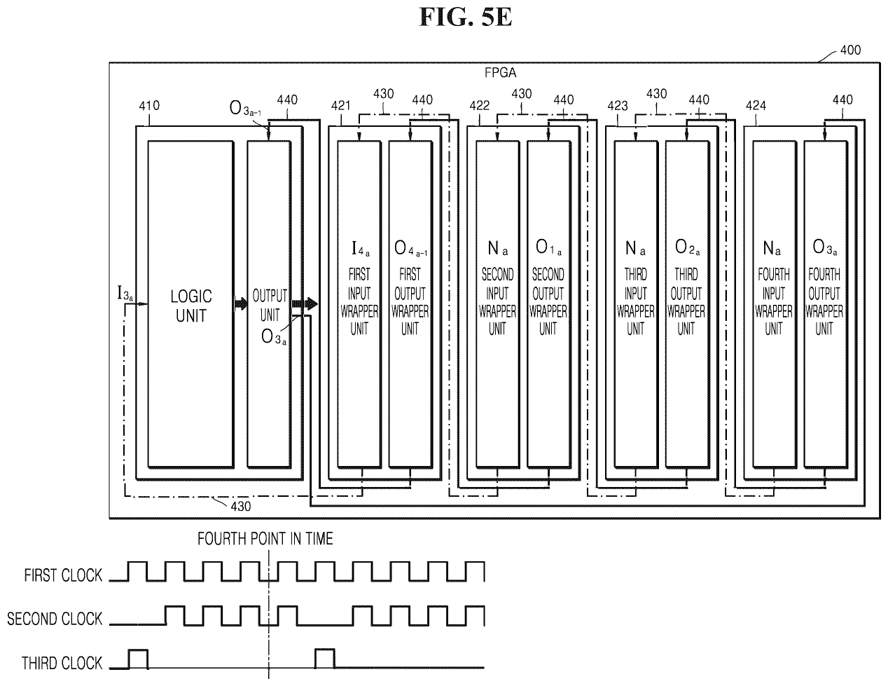

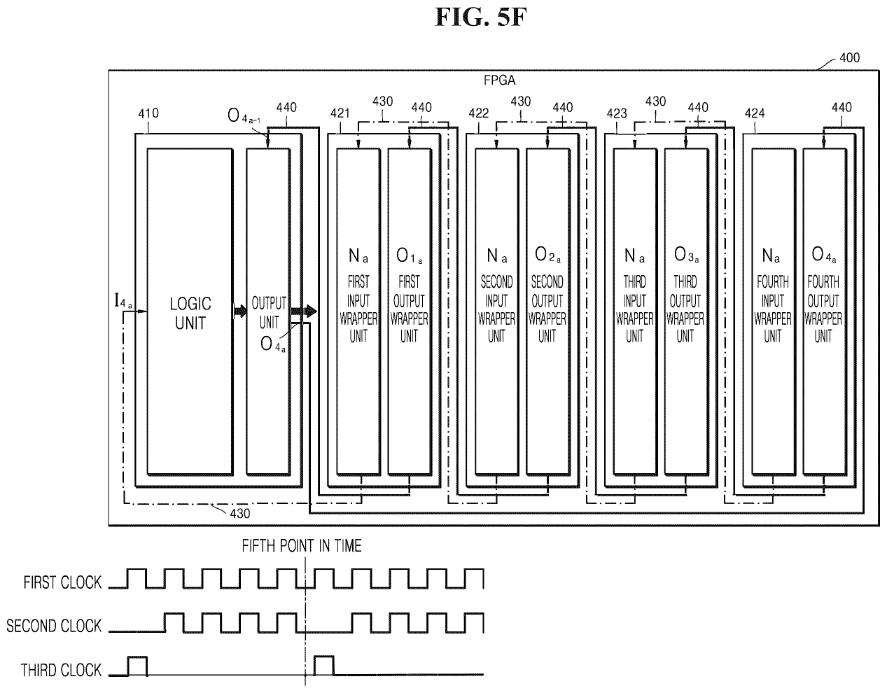

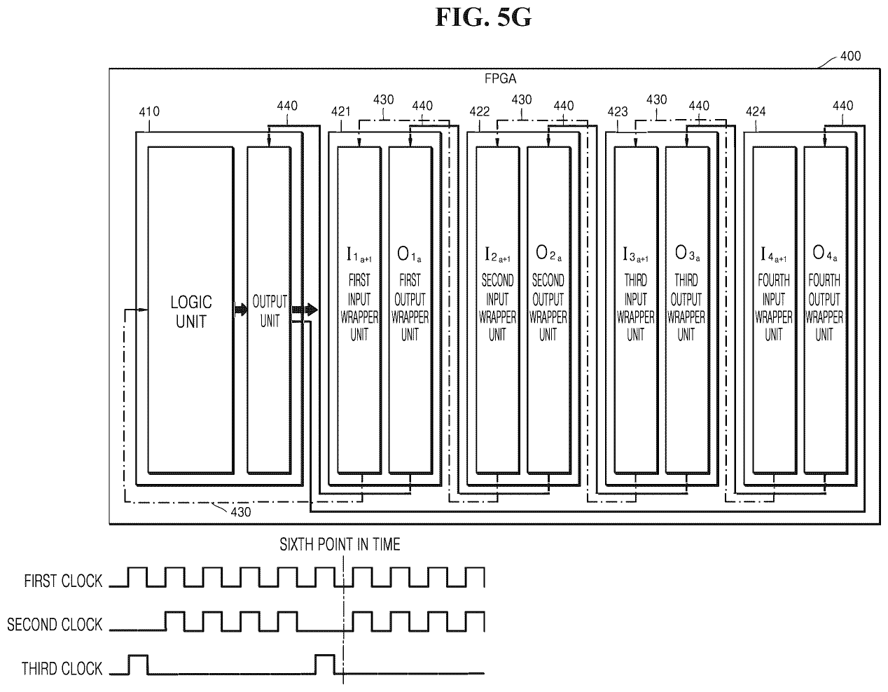

FIGS. 5A to 5G are diagrams for explaining in detail an example of data transmission in a FPGA to which a chain-based time-division multiplexing according to an embodiment of the present disclosure is applied. For example, a module of a FPGA 400 illustrated in FIGS. 5A to 5G may include a computation core 410 and/or a first wrapper core 421 to a fourth wrapper core 424.

For example, a clock for the FPGA 400 may include a first clock, a second clock, and/or a third clock. For example, the first clock may be a clock for an operation of input wrapper units of the wrapper cores, and the second clock may be a clock for an operation of output wrapper units of the wrapper cores and the computation core 410. Also, for example, the third clock may be a clock for an operation of a unit other than the module in the FPGA 400 that transmits input data. For example, the unit may be a VU, an XVU, or an AB, and the input data may be transmitted from the unit. For example, the FPGA 400 illustrated in FIGS. 5A to 5G may include units such as a VU, an XVU, and/or an AB in addition to the module.

Also, for example, the first clock may be a clock including an input pulse and operation pulses within a period, the second clock may be a clock including operation pulses within a period, and the third clock may include an input pulse. For example, the number of operation pulses within a period may be equal to the number of the wrapper cores. For example, when the number of the wrapper cores is N, the number of the operation pulses may be N.

Meanwhile, in FIGS. 5A to 5G, the module of the FPGA is illustrated as including four wrapper cores, but is not limited thereto and may be configured to include a different or greater number of wrapper cores. For example, the module of the FPGA may include N wrapper cores. That is, for example, the module of the FPGA may include a first wrapper core to a Nth wrapper core.

FIG. 5A may represent data states of the computation core 410 and the wrapper cores at a point in time before an a-th period starts. For example, at a point in time before the a-th period starts, the output wrapper units of the wrapper cores may store output data of an (a−1)-th period, which is a period preceding the a-th period. For example, referring to FIG. 5A, the first output wrapper unit of the first wrapper core 421 may store output data O1ₐ₋₁, the second output wrapper unit of the second wrapper core 422 may store output data O2ₐ₋₁, the third output wrapper unit of the third wrapper core 423 may store output data O3ₐ₋₁, and the fourth output wrapper unit of the fourth wrapper core 424 may store output data O4ₐ₋₁.

In addition, referring to FIG. 5A, the computation core 410 may include shift registers. The shift registers may store values for computation of the computation core 410. For example, the number of the shift registers may be equal to the number of the wrapper cores. For example, when the number of the wrapper cores is N, the number of the operation pulses may be N. For example, at a point in time before the a-th period starts, the shift registers may sequentially store values for a first computation to a Nth computation of the a-th period.

FIG. 5B may represent a data state of the computation core 410 and the wrapper cores at a first point in time of the a-th period. Referring to FIG. 5B, the first point in time may be a point in time after a first pulse of the first clock and a first pulse of the third clock occur. The first pulse of the first clock may be represented as an input pulse of the first clock. In addition, the first pulse of the third clock may be represented as an input pulse of the third clock.

For example, referring to FIG. 5B, input data of the a-th period may be transmitted to the input wrapper units of the wrapper cores at the input pulse of the third clock, and the input wrapper units may store the input data of the a-th period at the input pulse of the first clock. For example, at the input pulse within the a-th period of the first clock, the first input wrapper unit of the first wrapper core 421 may store input data I1ₐ, the second input wrapper unit of the second wrapper core 422 may store input data I2ₐ, the third input wrapper unit of the third wrapper core 423 may store input data I3ₐ, the fourth input wrapper unit of the fourth wrapper core 424 may store input data I4ₐ. That is, for example, a nth input wrapper unit of a nth wrapper core may store input data Inₐ at the input pulse within the a-th period of the first clock.

Meanwhile, referring to FIG. 5B, since a pulse for the second clock has not occurred, the output wrapper units of the wrapper cores may not operate and may be maintained in the previous state. In other words, since the second clock does not include an input pulse, the output wrapper units of the wrapper cores may not operate and may be maintained in the previous state. Accordingly, referring to FIG. 5B, the output wrapper units of the wrapper cores may store output data of an (a−1)-th period, which is a period preceding the a-th period.

FIG. 5C may represent a data state of the computation core 410 and the wrapper cores at a second point in time of the a-th period. Referring to FIG. 5C, the second point in time may be a point in time after a second pulse of the first clock and a first pulse of the second clock occur. The second pulse of the first clock may be represented as a first operation pulse of the first clock. In addition, the first pulse of the second clock may be represented as a first operation pulse of the second clock.

For example, referring to FIG. 5C, input data stored in the input wrapper units may be sequentially moved along the input wrapper chain at the first operation pulse of the first clock. For example, at the first operation pulse of the first clock, input data stored in a nth input wrapper unit may be moved to a (n−1)-th input wrapper unit, and input data of the first input wrapper unit may be transmitted to the logic unit of the computation core 410. Here, n may be greater than 1. Also, for example, the nth input wrapper unit may output input data that was stored, and if there is no input data, the nth input wrapper unit may be in a state (Na) where the input data is not stored.

For example, at the first operation pulse of the first clock, the fourth input wrapper unit of the fourth wrapper core 424 may output input data I4ₐ and transmit the input data I4ₐ to the third input wrapper unit of the third wrapper core 423, the third input wrapper unit of the third wrapper core 423 may store the input data I4ₐ, and may output input data I3ₐ and transmit the input data I3ₐ to the second input wrapper unit of the second wrapper core 422, the second input wrapper unit of the second wrapper core 422 may store the input data I3ₐ, and may output input data I2ₐ and transmit the input data I2ₐ to the first input wrapper unit of the first wrapper core 421, the first input wrapper unit of the first wrapper core 421 may store the input data I2ₐ, and may output input data I1ₐ and transmit the input data I1ₐ to the logic unit of the computation core 410. That is, for example, at the first operation pulse of the first clock, a nth input wrapper unit of the nth wrapper core may output stored input data and transmit the stored input data to a (n−1)-th input wrapper unit of the (n−1)-th wrapper core.

For example, at the first operation pulse of the first clock, input data I4ₐ stored in the fourth input wrapper unit of the fourth wrapper core 424 may be moved to the third input wrapper unit of the third wrapper core 423, input data I3ₐ stored in the third input wrapper unit of the third wrapper core 423 may be moved to the second input wrapper unit of the second wrapper core 422, input data I2ₐ stored in the second input wrapper unit of the second wrapper core 422 may be moved to the first input wrapper unit of the first wrapper core 421, and input data I1ₐ stored in the first input wrapper unit of the first wrapper core 421 may be transmitted to the logic unit of the computation core 410. That is, for example, at the first operation pulse of the first clock, input data stored in a nth input wrapper unit of a nth wrapper core may be moved to a (n−1)-th input wrapper unit of a (n−1)-th wrapper core, and input data stored in the first input wrapper unit of the first wrapper core 421 may be transmitted to the logic unit of the computation core 410. Here, n may be greater than 1.

In addition, for example, referring to FIG. 5C, output data stored in the output wrapper units may be sequentially moved along the output wrapper chain at a first operation pulse of the second clock. For example, at the first operation pulse of the second clock, output data stored in a nth output wrapper unit may be moved to a (n−1)-th output wrapper unit, output data of the first output wrapper unit may be transmitted to the output unit of the computation core 410, and the output unit of the computation core 410 may transmit output data of a first computation of an a-th period derived by performing the first computation to a last output wrapper unit (i.e., a N-th output wrapper unit). That is, the last output wrapper unit may store the output data of the first computation, and may transmit output data of a fourth computation of the (a−1)-th period, that was stored, to the output wrapper unit connected to the last output wrapper unit (i.e., the N−1-th output wrapper unit).

For example, at the first operation pulse of the second clock, the fourth output wrapper unit of the fourth wrapper core 424 may output output data O4ₐ₋₁ and may transmit the output data O4ₐ₋₁ to the third output wrapper unit of the third wrapper core 423, the third output wrapper unit of the third wrapper core 423 may store the output data O4ₐ₋₁, and may output output data O3ₐ₋₁ and transmit the output data O3ₐ₋₁ to the second output wrapper unit of the second wrapper core 422, the second output wrapper unit of the second wrapper core 422 may store the output data O3ₐ₋₁, and may output output data O2ₐ₋₁ and transmit the output data O2ₐ₋₁ to the first output wrapper unit of the first wrapper core 421, the first output wrapper unit of the first wrapper core 421 may store the output data O2ₐ₋₁, and may output output data O1ₐ₋₁ and transmit the output data O1ₐ₋₁ to the output unit of the computation core 410. That is, for example, at the first operation pulse of the second clock, a nth output wrapper unit of a nth wrapper core may output stored output data and transmit it to a (n−1)-th output wrapper unit of a (n−1)-th wrapper core. In addition, for example, at the first operation pulse of the second clock, the output unit of the computation core may perform a computation based on the input data I1ₐ and the output data O1ₐ₋₁ and output the derived output data O1ₐ and transmit it to the fourth output wrapper unit of the fourth wrapper core 424, and the fourth output wrapper unit may store the output data O1ₐ. That is, for example, at the first operation pulse of the second clock, the output unit of the computation core may output the output data derived by performing a computation and transmit the output data to the Nth output wrapper unit of the Nth wrapper core, and the Nth output wrapper unit may store the output data.

FIG. 5D may represent a data state of the computation core 410 and the wrapper cores at a third point in time of the a-th period. Referring to FIG. 5D, the third point in time may be a point in time after a third pulse of the first clock and a second pulse of the second clock occur. The third pulse of the first clock may be represented as a second operation pulse of the first clock. In addition, the second pulse of the second clock may be represented as a second operation pulse of the second clock.

For example, referring to FIG. 5D, input data stored in the input wrapper units may be sequentially moved along the input wrapper chain at the second operation pulse of the first clock. For example, at the second operation pulse of the first clock, input data stored in a nth input wrapper unit may be moved to a (n−1)-th input wrapper unit, and input data of the first input wrapper unit may be transmitted to the logic unit of the computation core 410. Here, n may be greater than 1. Also, for example, the nth input wrapper unit may output input data that was stored, and if there is no input data, the nth input wrapper unit may be in a state (Na) where the input data is not stored.

For example, at the second operation pulse of the first clock, the third input wrapper unit of the third wrapper core 423 may output input data I4ₐ and transmit the input data I4ₐ to the second input wrapper unit of the second wrapper core 422, the second input wrapper unit of the second wrapper core 422 may store the input data I4ₐ, and may output input data I3ₐ and transmit the input data I3ₐ to the first input wrapper unit of the first wrapper core 421, the first input wrapper unit of the first wrapper core 421 may store the input data I3ₐ, and may output input data I2ₐ and transmit the input data I2ₐ to the logic unit of the computation core 410. That is, for example, at the second operation pulse of the first clock, a nth input wrapper unit of the nth wrapper core may output stored input data and transmit the stored input data to a (n−1)-th input wrapper unit of the (n−1)-th wrapper core. Meanwhile, for example, at the second operation pulse of the first clock, if there is no input data stored in the nth input wrapper unit of the nth wrapper core, the nth input wrapper unit may not have input data to output, and the (n−1)-th input wrapper unit of the (n−1)-th wrapper core may be in a state (Na) where no input data is stored because there is no input data.

For example, at the second operation pulse of the first clock, input data I4ₐ stored in the third input wrapper unit of the third wrapper core 423 may be moved to the second input wrapper unit of the second wrapper core 422, input data I3ₐ stored in the second input wrapper unit of the second wrapper core 422 may be moved to the first input wrapper unit of the first wrapper core 421, and input data I2ₐ stored in the first input wrapper unit of the first wrapper core 421 may be transmitted to the logic unit of the computation core 410. That is, for example, at the second operation pulse of the first clock, input data stored in a nth input wrapper unit of a nth wrapper core may be moved to a (n−1)-th input wrapper unit of a (n−1)-th wrapper core, and input data stored in the first input wrapper unit of the first wrapper core 421 may be transmitted to the logic unit of the computation core 410. Here, n may be greater than 1.

In addition, for example, referring to FIG. 5D, output data stored in the output wrapper units may be sequentially moved along the output wrapper chain at a second operation pulse of the second clock. For example, at the second operation pulse of the second clock, output data stored in a nth output wrapper unit may be moved to a (n−1)-th output wrapper unit, output data of the first output wrapper unit may be transmitted to the output unit of the computation core 410, and the output unit of the computation core 410 may transmit output data of a second computation of an a-th period derived by performing the second computation to a last output wrapper unit (i.e., a N-th output wrapper unit). That is, the last output wrapper unit may store the output data of the second computation, and may transmit output data of a first computation of the a-th period, that was stored, to the output wrapper unit connected to the last output wrapper unit (i.e., the N−1-th output wrapper unit).

For example, at the second operation pulse of the second clock, the fourth output wrapper unit of the fourth wrapper core 424 may output output data O1ₐ and may transmit the output data O1ₐ to the third output wrapper unit of the third wrapper core 423, the third output wrapper unit of the third wrapper core 423 may store the output data O1ₐ, and may output output data O4ₐ₋₁ and transmit the output data O4ₐ₋₁ to the second output wrapper unit of the second wrapper core 422, the second output wrapper unit of the second wrapper core 422 may store the output data O4ₐ₋₁, and may output output data O3ₐ₋₁ and transmit the output data O3ₐ₋₁ to the first output wrapper unit of the first wrapper core 421, the first output wrapper unit of the first wrapper core 421 may store the output data O3ₐ₋₁, and may output output data O2ₐ₋₁ and transmit the output data O2ₐ₋₁ to the output unit of the computation core 410. That is, for example, at the second operation pulse of the second clock, a nth output wrapper unit of a nth wrapper core may output stored output data and transmit it to a (n−1)-th output wrapper unit of a (n−1)-th wrapper core. In addition, for example, at the second operation pulse of the second clock, the output unit of the computation core may perform a computation based on the input data I2ₐ and the output data O2ₐ₋₁ and output the derived output data O2ₐ and transmit it to the fourth output wrapper unit of the fourth wrapper core 424, and the fourth output wrapper unit may store the output data O2ₐ. That is, for example, at the second operation pulse of the second clock, the output unit of the computation core may output the output data derived by performing a computation and transmit the output data to the Nth output wrapper unit of the Nth wrapper core, and the Nth output wrapper unit may store the output data.

FIG. 5E may represent a data state of the computation core 410 and the wrapper cores at a fourth point in time of the a-th period. Referring to FIG. 5E, the fourth point in time may be a point in time after a fourth pulse of the first clock and a third pulse of the second clock occur. The fourth pulse of the first clock may be represented as a third operation pulse of the first clock. In addition, the third pulse of the second clock may be represented as a third operation pulse of the second clock.

For example, referring to FIG. 5E, input data stored in the input wrapper units may be sequentially moved along the input wrapper chain at the third operation pulse of the first clock. For example, at the third operation pulse of the first clock, input data stored in a nth input wrapper unit may be moved to a (n−1)-th input wrapper unit, and input data of the first input wrapper unit may be transmitted to the logic unit of the computation core 410. Here, n may be greater than 1. Also, for example, the nth input wrapper unit may output input data that was stored, and if there is no input data, the nth input wrapper unit may be in a state (Na) where the input data is not stored.

For example, at the third operation pulse of the first clock, the second input wrapper unit of the second wrapper core 422 may output input data I4ₐ and transmit the input data I4ₐ to the first input wrapper unit of the first wrapper core 421, the first input wrapper unit of the first wrapper core 421 may store the input data I4ₐ, and may output input data I3ₐ and transmit the input data I3ₐ to the logic unit of the computation core 410. That is, for example, at the third operation pulse of the first clock, a nth input wrapper unit of the nth wrapper core may output stored input data and transmit the stored input data to a (n−1)-th input wrapper unit of the (n−1)-th wrapper core. Meanwhile, for example, at the third operation pulse of the first clock, if there is no input data stored in the nth input wrapper unit of the nth wrapper core, the nth input wrapper unit may not have input data to output, and the (n−1)-th input wrapper unit of the (n−1)-th wrapper core may be in a state (Na) where no input data is stored because there is no input data.

For example, at the third operation pulse of the first clock, input data I4ₐ stored in the second input wrapper unit of the second wrapper core 422 may be moved to the first input wrapper unit of the first wrapper core 421, and input data I3ₐ stored in the first input wrapper unit of the first wrapper core 421 may be transmitted to the logic unit of the computation core 410. That is, for example, at the third operation pulse of the first clock, input data stored in a nth input wrapper unit of a nth wrapper core may be moved to a (n−1)-th input wrapper unit of a (n−1)-th wrapper core, and input data stored in the first input wrapper unit of the first wrapper core 421 may be transmitted to the logic unit of the computation core 410. Here, n may be greater than 1.

In addition, for example, referring to FIG. 5E, output data stored in the output wrapper units may be sequentially moved along the output wrapper chain at a third operation pulse of the second clock. For example, at the third operation pulse of the second clock, output data stored in a nth output wrapper unit may be moved to a (n−1)-th output wrapper unit, output data of the first output wrapper unit may be transmitted to the output unit of the computation core 410, and the output unit of the computation core 410 may transmit output data of a third computation of an a-th period derived by performing the third computation to a last output wrapper unit (i.e., a N-th output wrapper unit. That is, the last output wrapper unit may store the output data of the third computation, and may transmit output data of a second computation of the a-th period, that was stored, to the output wrapper unit connected to the last output wrapper unit (i.e., the N−1-th output wrapper unit).

For example, at the third operation pulse of the second clock, the fourth output wrapper unit of the fourth wrapper core 424 may output output data O2ₐ and may transmit the output data O2ₐ to the third output wrapper unit of the third wrapper core 423, the third output wrapper unit of the third wrapper core 423 may store the output data O2ₐ, and may output output data O1ₐ and transmit the output data O1ₐ to the second output wrapper unit of the second wrapper core 422, the second output wrapper unit of the second wrapper core 422 may store the output data O1ₐ, and may output output data O4ₐ₋₁ and transmit the output data O4ₐ₋₁ to the first output wrapper unit of the first wrapper core 421, the first output wrapper unit of the first wrapper core 421 may store the output data O4ₐ₋₁, and may output output data O3ₐ₋₁ and transmit the output data O3ₐ₋₁ to the output unit of the computation core 410. That is, for example, at the third operation pulse of the second clock, a nth output wrapper unit of a nth wrapper core may output stored output data and transmit it to a (n−1)-th output wrapper unit of a (n−1)-th wrapper core. In addition, for example, at the third operation pulse of the second clock, the output unit of the computation core may perform a computation based on the input data I3ₐ and the output data O3ₐ₋₁ and output the derived output data O3ₐ and transmit it to the fourth output wrapper unit of the fourth wrapper core 424, and the fourth output wrapper unit may store the output data O3ₐ. That is, for example, at the third operation pulse of the second clock, the output unit of the computation core may output the output data derived by performing a computation and transmit the output data to the Nth output wrapper unit of the Nth wrapper core, and the Nth output wrapper unit may store the output data.

FIG. 5F may represent a data state of the computation core 410 and the wrapper cores at a fifth point in time of the a-th period. Referring to FIG. 5F, the fifth point in time may be a point in time after a fifth pulse of the first clock and a fourth pulse of the second clock occur. The fifth pulse of the first clock may be represented as a fourth operation pulse of the first clock. In addition, the fourth pulse of the second clock may be represented as a fourth operation pulse of the second clock.

For example, referring to FIG. 5F, input data stored in the input wrapper units may be sequentially moved along the input wrapper chain at the fourth operation pulse of the first clock. For example, at the fourth operation pulse of the first clock, input data stored in a nth input wrapper unit may be moved to a (n−1)-th input wrapper unit, and input data of the first input wrapper unit may be transmitted to the logic unit of the computation core 410. Here, n may be greater than 1. Also, for example, the nth input wrapper unit may output input data that was stored, and if there is no input data, the nth input wrapper unit may be in a state (Na) where the input data is not stored.

For example, at the fourth operation pulse of the first clock, the first input wrapper unit of the first wrapper core 421 may output input data I4ₐ and transmit the input data I4ₐ to the logic unit of the computation core 410. That is, for example, at the fourth operation pulse of the first clock, a nth input wrapper unit of the nth wrapper core may output stored input data and transmit the stored input data to a (n−1)-th input wrapper unit of the (n−1)-th wrapper core. Meanwhile, for example, at the fourth operation pulse of the first clock, if there is no input data stored in the nth input wrapper unit of the nth wrapper core, the nth input wrapper unit may not have input data to output, and the (n−1)-th input wrapper unit of the (n−1)-th wrapper core may be in a state (Na) where no input data is stored because there is no input data.

For example, at the fourth operation pulse of the first clock, input data I4ₐ stored in the first input wrapper unit of the first wrapper core 421 may be transmitted to the logic unit of the computation core 410. That is, for example, at the fourth operation pulse of the first clock, input data stored in the first input wrapper unit of the first wrapper core 421 may be transmitted to the logic unit of the computation core 410.

In addition, for example, referring to FIG. 5F, output data stored in the output wrapper units may be sequentially moved along the output wrapper chain at a fourth operation pulse of the second clock. For example, at the fourth operation pulse of the second clock, output data stored in a nth output wrapper unit may be moved to a (n−1)-th output wrapper unit, output data of the first output wrapper unit may be transmitted to the output unit of the computation core 410, and the output unit of the computation core 410 may transmit output data of a fourth computation of an a-th period derived by performing the fourth computation to a last output wrapper unit (i.e., a N-th output wrapper unit). That is, the last output wrapper unit may store the output data of the fourth computation, and may transmit output data of a third computation of the a-th period, that was stored, to the output wrapper unit connected to the last output wrapper unit (i.e., the N−1-th output wrapper unit).

For example, at the fourth operation pulse of the second clock, the fourth output wrapper unit of the fourth wrapper core 424 may output output data O3ₐ and may transmit the output data O3ₐ to the third output wrapper unit of the third wrapper core 423, the third output wrapper unit of the third wrapper core 423 may store the output data O3ₐ, and may output output data O2ₐ and transmit the output data O2ₐ to the second output wrapper unit of the second wrapper core 422, the second output wrapper unit of the second wrapper core 422 may store the output data O2ₐ, and may output output data O1ₐ and transmit the output data O1ₐ to the first output wrapper unit of the first wrapper core 421, the first output wrapper unit of the first wrapper core 421 may store the output data O1ₐ, and may output output data O4ₐ₋₁ and transmit the output data O4ₐ₋₁ to the output unit of the computation core 410. That is, for example, at the fourth operation pulse of the second clock, a nth output wrapper unit of a nth wrapper core may output stored output data and transmit it to a (n−1)-th output wrapper unit of a (n−1)-th wrapper core. In addition, for example, at the fourth operation pulse of the second clock, the output unit of the computation core may perform a computation based on the input data I4ₐ and the output data O4ₐ₋₁ and output the derived output data O4ₐ and transmit it to the fourth output wrapper unit of the fourth wrapper core 424, and the fourth output wrapper unit may store the output data O4ₐ. That is, for example, at the fourth operation pulse of the second clock, the output unit of the computation core may output the output data derived by performing a computation and transmit the output data to the Nth output wrapper unit of the Nth wrapper core, and the Nth output wrapper unit may store the output data.

FIG. 5G may represent a data state of the computation core 410 and the wrapper cores at a sixth point in time of the a-th period. Referring to FIG. 5G, the sixth point in time may be a point in time after a first pulse of an (a+1)-th period of the first clock and a first pulse of an (a+1)-th period of the third clock occur. The first pulse of the (a+1)-th period of the first clock may be represented as an input pulse of the (a+1)-th period of the first clock. In addition, the first pulse of the (a+1)-th period of the third clock may be represented as an input pulse of the (a+1)-th period of the third clock.

For example, referring to FIG. 5G, input data of the (a+1)-th period may be transmitted to the input wrapper units of the wrapper cores at the input pulse of the (a+1)-th period of the third clock, and the input wrapper units may store the input data of the (a+1)-th period at the input pulse of the (a+1)-th period of the first clock. For example, at the input pulse within the (a+1)-th period of the first clock, the first input wrapper unit of the first wrapper core 421 may store input data I1ₐ₊₁, the second input wrapper unit of the second wrapper core 422 may store input data I2ₐ₊₁, the third input wrapper unit of the third wrapper core 423 may store input data I3ₐ₊₁, the fourth input wrapper unit of the fourth wrapper core 424 may store input data I4ₐ₊₁. That is, for example, a nth input wrapper unit of a nth wrapper core may store input data Inₐ₊₁ at the input pulse within the (a+1)-th period of the first clock.

Meanwhile, referring to FIG. 5G, since a pulse of the (a+1)-th period for the second clock has not occurred, the output wrapper units of the wrapper cores may not operate and may be maintained in the previous state. In other words, since the second clock does not include an input pulse, the output wrapper units of the wrapper cores may not operate and may be maintained in the previous state. Accordingly, referring to FIG. 5G, the output wrapper units of the wrapper cores may store output data of the ath period, which is a period preceding the (a+1)-th period.

Meanwhile, a specific description of a clock of the FPGA to which the chain-based time-division multiplexing proposed in the present disclosure is applied may be as follows.

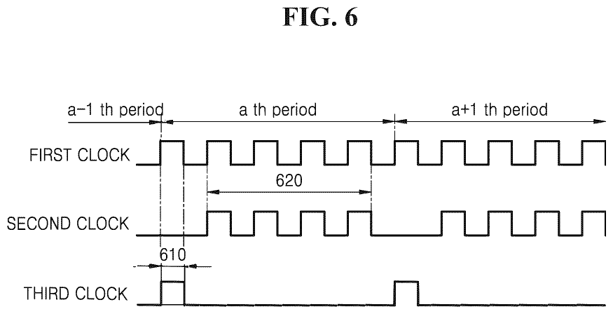

FIG. 6 is a diagram for explaining in detail an embodiment of a clock of a FPGA to which a chain-based time-division multiplexing according to an embodiment of the present disclosure is applied.

Referring to FIG. 6, a clock of the FPGA to which the chain-based time-division multiplexing is applied may include a first clock, a second clock, and/or a third clock. The clock may mean a signal that serves as a reference for an operation of the processing configuration of the FPGA.

For example, the first clock may be a clock for an operation of input wrapper units of the wrapper cores, and the second clock may be a clock for an operation of output wrapper units of the wrapper cores and the computation core. Also, for example, the third clock may be a clock for an operation of a unit that transmits input data.

For example, referring to FIG. 6, when the number of wrapper cores of the module of the FPGA is N, the first clock may include N+1 pulses in one period, the second clock may include N pulses in one period, and the third clock may include 1 pulse in one period. For example, as shown in FIG. 6, the first clock may include an input pulse 610 and operation pulses 620, the second clock may include operation pulses 620, and the third clock may include an input pulse 610. For example, the input pulse 610 of the first clock may correspond to the third clock, and the operation pulses 620 of the first clock may correspond to the second clock.

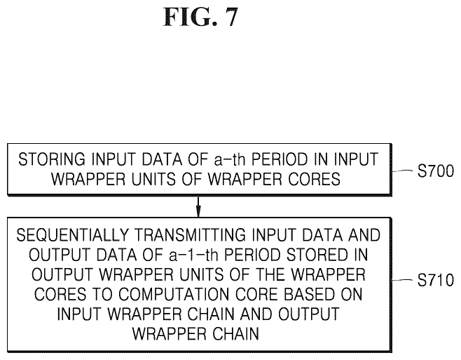

FIG. 7 is a flowchart for explaining in detail a data processing method in a FPGA according to an embodiment of the present disclosure.

The FPGA stores input data of an a-th period in input wrapper units of wrapper cores including a first wrapper core to a N-th wrapper core at S700.

For example, a module of the FPGA may include a computation core including a logic unit and an output unit, and wrapper cores including a first wrapper core to a N-th wrapper core. For example, each of the wrapper cores may include an input wrapper unit storing input data and an output wrapper unit storing output data. For example, a n-th wrapper core may include a n-th input wrapper unit storing input data and a n-th output wrapper unit storing output data. In addition, for example, each of the input wrapper units and the output wrapper units may be a register consisting of at least one flip-flop.

In addition, for example, the input wrapper chain may be a circuit in which the input wrapper units of the wrapper cores and the logic unit of the computation core are connected, and the output wrapper chain may be a circuit in which the output unit of the computation core and the output wrapper units of the wrapper cores are connected.

Specifically, for example, the input wrapper chain may be a circuit in which the input wrapper units of the wrapper cores and the logic unit of the computation core are connected in series. For example, the input wrapper chain may be a circuit in which a first input wrapper unit of the first wrapper core is sequentially connected to a Nth input wrapper unit of the Nth wrapper core, and the first input wrapper unit is connected to the logic unit of the computation core.

In addition, for example, the output wrapper chain may be a circuit in which the output wrapper units of the wrapper cores and the output unit of the computation core are connected in a loop structure. For example, the output wrapper chain may be a circuit in which a Nth output wrapper unit of the Nth wrapper core is sequentially connected to a first output wrapper unit of the first wrapper core, the first output wrapper unit is connected to the output part of the computation core, and the output part is connected to the Nth output wrapper unit of the Nth wrapper core.

In addition, for example, the input wrapper units may operate according to a first clock, and the output wrapper units and the computation core may operate according to a second clock. In addition, for example, a unit that transfers input data to the input wrapper units may operate according to a third clock. For example, the first clock may be a signal having a period including an input pulse and operation pulses, and the second clock may be a signal having a period including the operation pulses. In addition, for example, the third clock may be a signal having a period including an input pulse. For example, an input pulse of the first clock may correspond to the third clock. That is, for example, an input pulse of the first clock may correspond to an input pulse of the third clock. In addition, for example, operation pulses of the first clock may correspond to the second clock. That is, for example, operation pulses of the first clock may correspond to operation pulses of the third clock. Periods of the first clock, the second clock and/or the third clock may be the same.

For example, at the input pulse of the a-th period of the first clock, the input data of the a-th period may be stored in the input wrapper units. For example, at the input pulse of the a-th period of the first clock, the input wrapper units may store the input data of the a-th period that is transmitted. Meanwhile, for example, the output wrapper units may store the output data of an (a−1)-th period, which is a previous period. That is, the output data of the (a−1)-th period may be stored in the output wrapper units of the wrapper cores.

The FPGA sequentially transmits the input data of the a-th period and output data of an (a−1)-th period stored in the output wrapper units of the wrapper cores to the computation core based on an input wrapper chain and an output wrapper chain at S710.

For example, the input data of the a-th period may include first input data to N-th input data of the a-th period, and the output data of the (a−1)-th period may include first output data to N-th output data of the (a−1)-th period. Here, N may be the number of the wrapper cores.

For example, according to operation pulses of the a-th period of the first clock, the input data of the a-th period may be sequentially moved through the input wrapper chain, and according to operation pulses of the a-th period of the second clock, the output data of the (a−1)-th period may be sequentially moved through the output wrapper chain.

Specifically, for example, input data of the a-th period stored in a n-th input wrapper unit of a n-th wrapper core may be moved to a n−1-th input wrapper unit of a n−1-th wrapper core, and input data of the a-th period stored in a first input wrapper unit of the first wrapper core may be transmitted to the logic unit. Here, n may be greater than 1. Meanwhile, when there is no input data stored in the n-th input wrapper unit, the n−1-th input wrapper unit may be in a state of not storing input data (state Na) since there is no input data to be transmitted.

In addition, for example, output data of the (a−1)-th period stored in a n-th output wrapper unit of a n-th wrapper core may be moved to a (n−1)-th output wrapper unit of a (n−1)-th wrapper core, and output data of the (a−1)-th period stored in a first output wrapper unit of the first wrapper core may be transmitted to the output unit. Here, n may be greater than 1.

In addition, for example, a module of the FPGA may sequentially perform, by the computation core, a first computation performed based on the first input data and the first output data to an Nth computation performed based on the Nth input data and the Nth output data, and may derive and output first output data to Nth output data of the a-th period by the first computation to the Nth computation.

That is, for example, by the computation core, a first computation performed based on the first input data and the first output data to a Nth computation performed based on the Nth input data and the Nth output data are sequentially performed. First output data to Nth output data of the a-th period may be derived from the first computation to the Nth computation.

For example, the first output data to the Nth output data of the a-th period may be sequentially moved through the output wrapper chain. Specifically, for example, the output data of the a-th period output from the output unit of the computation core may be moved to a (n−1)-th output wrapper unit of the N-th wrapper core, and the output data of the a-th period stored in a nth output wrapper unit of a nth wrapper core may be moved to a (n−1)-th output wrapper unit of a (n−1)-th wrapper core.

Hereinafter, embodiments in accordance with various aspects will be described.

In some aspects, a processor comprises: a parallel-in serial-out (PISO) shift register having a plurality of input ports configured to parallelly receive a plurality of electronic logic signals, the PISO shift register being configured to store the plurality of electronic logic signals and serially output the stored electronic logic signals to an output port of the PISO shift register; a first combinational logic circuit having a first input port electrically connected to the output port of the PISO shift register, the first combinational logic circuit being configured to generate an electronic logic signal to be output to a first output port of the first combinational logic circuit based on an electronic logic signal applied to the first input port of the first combinational logic circuit; and a serial-in parallel-out (SIPO) shift register having an input port electrically connected to the first output port of the first combinational logic circuit, the SIPO shift register being configured to shift stored electronic logic signals with an electronic logic signal applied to the input port of the SIPO shift register and parallelly output stored electronic logic signals through a plurality of output ports of the SIPO shift register.

In some aspects, the processor further comprises: a serial-in serial-out (SISO) shift register having an input port electrically connected to a second output port of the first combinational logic circuit and an output port electrically connected to a second input port of the first combinational logic circuit, wherein the SISO shift register is configured to shift stored electronic logic signals with an electronic logic signal applied to the input port of the SISO shift register and serially output stored electronic logic signals through the output port of the SISO shift register.

In some aspects, wherein the first combinational logic circuit is further configured to generate an electronic logic signal to be output to the first output port of the first combinational logic circuit and an electronic logic signal to be output to the second output port of the first combinational logic circuit based on an electronic logic signal applied to the first input port of the first combinational logic circuit and an electronic logic signal applied to the second input port of the first combinational logic circuit.

In some aspects, wherein the SIPO shift register further has a serial output port configured to serially output stored electronic logic signals, and the first combinational logic circuit further has a third input port electrically connected to the serial output port of the SIPO shift register.

In some aspects, wherein the first combinational logic circuit is further configured to generate an electronic logic signal to be output to the first output port of the first combinational logic circuit and an electronic logic signal to be output to the second output port of the first combinational logic circuit based on an electronic logic signal applied to the first input port of the first combinational logic circuit, an electronic logic signal applied to the second input port of the first combinational logic circuit, and an electronic logic signal applied to the third input port of the first combinational logic circuit.

In some aspects, wherein the first combinational logic circuit is configured to perform a plurality of computations during a stage.

In some aspects, wherein a first clock signal is applied to the PISO shift register,
the first clock signal makes a first clock causing the PISO shift register to parallelly receive a plurality of electronic logic signals for a current stage.

In some aspects, the first clock signal makes a plurality of clocks following the first clock causing the PISO shift register to serially output the plurality of electronic logic signals applied to the plurality of input ports of the PISO shift register.

In some aspects, the number of plurality of clocks of the first clock signal is equal to the plurality of computations.

In some aspects, a second clock signal is applied to the SIPO shift register, the second clock signal makes a plurality of clocks causing the SIPO shift register to shift stored electronic logic signals with an electronic logic signal applied to the input port of the SIPO shift register and parallelly output stored electronic logic signals through the plurality of output ports of the SIPO shift register at a respective one clock of the plurality of clocks of the second clock, and the plurality of clocks of the second clock follows the first clock of the first clock signal.

In some aspects, the number of plurality of clocks of the second clock signal is equal to the plurality of computations.

In some aspects, a third clock signal is applied to the SISO shift register, the third clock signal makes a plurality of clocks causing the SISO shift register to shift stored electronic logic signals with an electronic logic signal applied to the input port of the SISO shift register and serially output stored electronic logic signals through the output port of the SISO shift register at a respective one clock of the plurality of clocks of the third clock, and the plurality of clocks of the third clock follows the first clock of the first clock signal.

In some aspects, the number of plurality of clocks of the third clock signal is equal to the plurality of computations.

In some aspects, the SISO shift register comprises: a plurality of flip-flops which are connected in serial.

In some aspects, the PISO shift register comprises: a plurality of multiplexers, each of which is associated with a respective one of the plurality of input ports of the PISO shift register, wherein a first input port of each of the plurality of multiplexers is electrically connected to an associated input port of the PISO shift register; and a plurality of flip-flops, each of which is associated with a respective one of the plurality of multiplexers, wherein an input port of each of the plurality of flip-flops is electrically connected to an output port of an associated multiplexer.

In some aspects, the SIPO shift register comprises: a plurality of flip-flops which are connected in serial.

In some aspects, the processor further comprises: a second combinational logic circuit having a first set of input ports electrically connected to the plurality of output ports of the SIPO shift register, the second combinational logic circuit being configured to generate a plurality of electronic logic signals based on a plurality of electronic logic signals applied to the first set of input ports of the second combinational logic circuit and parallelly output the plurality of generated electronic logic signals to a plurality of output ports of the second combinational logic circuit.

In some aspects, the second combinational logic circuit further has a second set of input ports configured to receive a plurality of electronic logic signals applied to the plurality of input ports of the PISO shift register.

In some aspects, the second combinational logic circuit is configured to generate a plurality of electronic logic signals based on a plurality of electronic logic signals applied to the first set of input ports of the second combinational logic circuit and a plurality of electronic logic signals applied to the second set of input ports of the second combinational logic circuit.

The FPGA according to embodiments described above may be configured with a module that repeatedly performs the entire computation through a single computation core instead of including multiple modules for multiple calculations, and may generate an effect of overcoming the limitation of FPGA capacity restrictions by saving the resource capacity required for computation for implementing chip design through the circuit.

In addition, the complexity of configuring a circuit to be repeatedly performed in units of computation cores may be reduced, saving time for FPGA configuration and improving the efficiency of chip design implementation.

In addition, additional controls that may incur overhead during the computation process for chip implementation may not be required, thereby reducing complexity and increasing efficiency.

Although the present disclosure described above has been described with reference to the embodiments illustrated in the drawings, these are merely exemplary, and those skilled in the art will understand that various modifications and variations of the embodiments are possible. That is, the scope of the present disclosure is not limited to the above-described embodiments, and various modifications and improvements made by those skilled in the art using the basic concept of the embodiments defined in the following claims also included in the scope of the embodiments. Therefore, the scope of the present disclosure is defined by the technical spirit of the appended claims.

What is claimed is:

1. A processor comprising:
a parallel-in serial-out (PISO) shift register having a plurality of input ports configured to parallelly receive a plurality of electronic logic signals, the PISO shift register being configured to store the plurality of electronic logic signals and serially output the stored electronic logic signals to an output port of the PISO shift register;
a first combinational logic circuit having a first input port electrically connected to the output port of the PISO shift register, the first combinational logic circuit being configured to generate an electronic logic signal to be output to a first output port of the first combinational logic circuit based on an electronic logic signal applied to the first input port of the first combinational logic circuit; and
a serial-in parallel-out (SIPO) shift register having an input port electrically connected to the first output port of the first combinational logic circuit, the SIPO shift register being configured to shift stored electronic logic signals with an electronic logic signal applied to the input port of the SIPO shift register and parallelly output stored electronic logic signals through a plurality of output ports of the SIPO shift register.

2. The processor of claim 1, further comprising:
a serial-in serial-out (SISO) shift register having an input port electrically connected to a second output port of the first combinational logic circuit and an output port electrically connected to a second input port of the first combinational logic circuit,
wherein the SISO shift register is configured to shift stored electronic logic signals with an electronic logic signal applied to the input port of the SISO shift register and serially output stored electronic logic signals through the output port of the SISO shift register.

3. The processor of claim 2, wherein the first combinational logic circuit is further configured to generate an electronic logic signal to be output to the first output port of the first combinational logic circuit and an electronic logic signal to be output to the second output port of the first combinational logic circuit based on an electronic logic signal applied to the first input port of the first combinational logic circuit and an electronic logic signal applied to the second input port of the first combinational logic circuit.

4. The processor of claim 3, wherein the SIPO shift register further has a serial output port configured to serially output stored electronic logic signals, and
the first combinational logic circuit further has a third input port electrically connected to the serial output port of the SIPO shift register.

5. The processor of claim 4, wherein the first combinational logic circuit is further configured to generate an electronic logic signal to be output to the first output port of the first combinational logic circuit and an electronic logic signal to be output to the second output port of the first combinational logic circuit based on an electronic logic signal applied to the first input port of the first combinational logic circuit, an electronic logic signal applied to the second input port of the first combinational logic circuit, and an electronic logic signal applied to the third input port of the first combinational logic circuit.

6. The processor of claim 2, wherein the first combinational logic circuit is configured to perform a plurality of computations during a stage.

7. The processor of claim 6, wherein a first clock signal is applied to the PISO shift register, the first clock signal makes a first clock causing the PISO shift register to parallelly receive a plurality of electronic logic signals for a current stage.

8. The processor of claim 7, wherein the first clock signal makes a plurality of clocks following the first clock causing the PISO shift register to serially output the plurality of electronic logic signals applied to the plurality of input ports of the PISO shift register.

9. The processor of claim 8, wherein the number of plurality of clocks of the first clock signal is equal to the plurality of computations.

10. The processor of claim 6, wherein a second clock signal is applied to the SIPO shift register,
the second clock signal makes a plurality of clocks causing the SIPO shift register to shift stored electronic logic signals with an electronic logic signal applied to the input port of the SIPO shift register and parallelly output stored electronic logic signals through the plurality of output ports of the SIPO shift register at a respective one clock of the plurality of clocks of the second clock, and
the plurality of clocks of the second clock follows the first clock of the first clock signal.

11. The processor of claim 10, wherein the number of plurality of clocks of the second clock signal is equal to the plurality of computations.

12. The processor of claim 6, wherein a third clock signal is applied to the SISO shift register,
the third clock signal makes a plurality of clocks causing the SISO shift register to shift stored electronic logic signals with an electronic logic signal applied to the input port of the SISO shift register and serially output stored electronic logic signals through the output port of the SISO shift register at a respective one clock of the plurality of clocks of the third clock, and
the plurality of clocks of the third clock follows the first clock of the first clock signal.

13. The processor of claim 12, wherein the number of plurality of clocks of the third clock signal is equal to the plurality of computations.

14. The processor of claim 2, wherein the SISO shift register comprises:
a plurality of flip-flops which are connected in serial.

15. The processor of claim 1, wherein the PISO shift register comprises:
a plurality of multiplexers, each of which is associated with a respective one of the plurality of input ports of the PISO shift register, wherein a first input port of each of the plurality of multiplexers is electrically connected to an associated input port of the PISO shift register; and
a plurality of flip-flops, each of which is associated with a respective one of the plurality of multiplexers, wherein an input port of each of the plurality of flip-flops is electrically connected to an output port of an associated multiplexer.

16. The processor of claim 1, wherein the SIPO shift register comprises:
a plurality of flip-flops which are connected in serial.

17. The processor of claim 1, further comprising:
a second combinational logic circuit having a first set of input ports electrically connected to the plurality of output ports of the SIPO shift register, the second combinational logic circuit being configured to generate a plurality of electronic logic signals based on a plurality of electronic logic signals applied to the first set of input ports of the second combinational logic circuit and parallelly output the plurality of generated electronic logic signals to a plurality of output ports of the second combinational logic circuit.

18. The processor of claim 10, wherein the second combinational logic circuit further has a second set of input ports configured to receive a plurality of electronic logic signals applied to the plurality of input ports of the PISO shift register.

19. The processor of claim 14, wherein the second combinational logic circuit is configured to generate a plurality of electronic logic signals based on a plurality of electronic logic signals applied to the first set of input ports of the second combinational logic circuit and a plurality of electronic logic signals applied to the second set of input ports of the second combinational logic circuit.
